(19) United States
(12) Patent Application Publication
(10) Pub. No.: US 2026/0223888 A1
(43) Pub. Date: Aug. 6, 2026

(54) A PROCESS FOR PRODUCING A PROTEIN ISOLATE FROM A GRAIN MATERIAL AND A PROTEIN ISOLATE PRODUCED THEREFROM

(71) Applicant: Anheuser-Busch InBev S.A., Brussels (BE)

(72) Inventors: Sofie FREDERIX, Leuven (BE); Steffen MUENCH, Leuven (BE); Tom SCHEIRS, Leuven (BE)

(21) Appl. No.: 19/151,232

(22) PCT Filed: Jan. 30, 2024
(86) PCT No.: PCT/EP2024/052170

§ 371 Date: Jul. 25, 2025

(30) Foreign Application Priority Data
Jan. 30, 2023 (BE) BE2023/5057

(51) Int. Cl. A23J 3/34; A23C 11/06; A23J 1/12; A23L 2/66; B01D 61/02; B01D 61/14; B01D 61/58; C12F 3/06

(52) U.S. Cl. CPC A23J 3/346; A23C 11/06; A23J 1/125; A23L 2/66; B01D 61/58; C12F 3/06; B01D 61/027; B01D 61/147; B01D 2317/025

(57) ABSTRACT

The present invention provides a process for producing a protein isolate from grain material which includes a step of treating the liquid protein stream with a bleaching agent to reduce the colour of the protein isolate. The present invention also provides a protein isolate and food and beverage products comprising the protein isolate.

### FIELD OF THE INVENTION

The present invention is directed to a process for isolating a protein isolate from a grain material, in particular from brewer's spent grain, by enzymatic hydrolysis, wherein the process comprises a step of treating a liquid protein stream with a bleaching agent. The present invention is also directed to a protein isolate isolated from a grain material and food and beverage products comprising the protein isolate.

### BACKGROUND TO THE INVENTION

The use of protein isolates and supplements is well known in the art. For example, many people utilise protein isolates to make beverages or other foodstuffs as part of a training regimen to provide additional protein for muscle growth. In addition, people may utilise protein supplements when their daily diet is insufficient to satisfy the human body's daily protein requirements. In addition, individuals with specific diets that do not allow for the consumption of traditional meat-based protein sources may supplement their diets with protein isolates to meet their daily requirements.

Traditionally, protein isolates and supplements have generally been whey-, soy- or casein-based products. Whey and casein proteins are generally recovered as a by-product from dairy production, with whey being isolated from cheese production and casein being isolated from milk. Soy proteins are isolated from soybeans. While whey, soy and casein-based protein powders and supplements are used to successfully provide beneficial amounts of protein, the latter are not always suitable for people having food intolerances or allergies such as lactose intolerance. While plant based protein isolates exist that provide less immunogenic effects, these products are typically perceived to have a less pleasant taste and are also less soluble than, for instance, their whey counterparts. As such, the consumer may be less inclined to opt for these alternatives.

Brewer's spent grain (BSG) is the most abundant by-product generated in the beer-brewing process. This material comprises malt and grain husks obtained as a solid fraction after the mash filtration or lautering step. To date, this brewery by-product has mainly been put to low value uses, in particular as an animal feed.

BSG is rich in nutrients, particularly protein and fibre. Protein isolates have been produced using BSG, such as disclosed in WO 2021/028509 A1, US 2018/0199593 A1 and US 2018/0199594 A1. It has been found that protein isolates isolated from BSG can be dark in colour and have a bitter flavour, which can reduce their usefulness in preparing protein-enriched food and beverages. Attempts have been made to bleach protein isolates from other protein sources, including whey (Jervis et al, Effect of bleaching whey on sensory and functional properties, J. Dairy Sci., 2012, 95(6), 2848-2862). However, the present inventors have discovered that the conditions used in the prior art do not significantly reduce the lightness and colour of protein isolates isolated from BSG. Accordingly, there remains a need for a process for isolating a protein isolate from BSG which has a light colour and low overall flavour and aroma.

### SUMMARY OF THE INVENTION

The present invention is directed to a process for isolating a protein isolate from a grain material, in particular brewer's spent grain, involving enzymatic hydrolysis and a step of treating the liquid protein stream with a bleaching agent. The present invention is also directed to a protein isolate which has a light colour and a low overall flavour and aroma, allowing it to be readily mixed with other ingredients to produce protein-enriched comestibles. The present invention is therefore also directed to food and beverage products comprising the protein isolates of the present invention.

Viewed from a first aspect, the present invention is a process for isolating a protein isolate from a grain material, the process comprising:
a) subjecting an aqueous slurry of the grain material to enzymatic protein hydrolysis to produce a liquid protein stream;
b) removing solids from the liquid protein stream;
c) subjecting the liquid protein stream to one or more filtration steps;
d) processing the liquid protein stream to produce the protein isolate;
   wherein the process further comprises, either during or after step (c), a step of treating the liquid protein stream with a bleaching agent at a temperature of at least 50° C. and a pH of at least 5.

Viewed from a second aspect, the present invention is directed to a protein isolate obtainable by the process of the present invention.

Viewed from a third aspect, the present invention is directed to a protein isolate isolated from a grain material, preferably brewer's spent grain, wherein the protein isolate has an L* score of at least 60, preferably 70 to 100, more preferably 75 to 98 in aqueous solution at 5% protein by weight, as measured by the CIELAB method.

Viewed from a fourth aspect, the present invention is directed to a food or beverage comprising the protein isolate obtainable by the process of the present invention.

Viewed from a fifth aspect, the present invention is directed to a food or beverage comprising the protein isolate according to the present invention.

Further beneficial features of the present invention are set out in the description and the dependent claims.

### DESCRIPTION OF THE DRAWINGS

FIG. 1 shows a flowchart schematically representing a specific embodiment of the invention in which bleaching occurs between a microfiltration step and a nanofiltration step.

FIG. 2 shows a flowchart schematically representing a specific embodiment of the invention in which bleaching occurs between two nanofiltration steps.

FIG. 3 shows the lightness (L* score) during the bleaching step described in Example 1.

FIG. 4 shows the lightness (L* score) during the bleaching step described in Example 2.

FIGS. 5A and 5B show the lightness (L* score) during the bleaching steps described in Example 3. FIG. 5A shows the lightness during the bleaching treatment at a dosage of 10× (175 g/kg of protein) at the stated temperatures and FIG. 5B shows the lightness during the bleaching treatment at a dosage of 5× (87.5 g/kg of protein) at the stated temperatures.

FIG. 6 shows the results of the sensory profile testing described in Table 15 of Example 7.

FIG. 7 shows the solubility of the protein isolate of the present invention at 2% protein concentration, a commercial soy protein product, and a commercial pea protein product.

FIG. 8A shows the viscosity of the protein isolate of the present invention at 2% protein concentration and FIG. 8B shows the viscosity of the protein isolate of the present invention at 2% protein concentration compared to a commercial soy protein product, a commercial pea protein product, and a commercial whey protein product.

FIG. 9 shows the molecular weight distribution of the protein isolate of the present invention.

FIG. 10 shows the results of sensory profile testing of the protein isolate of the present invention compared to a commercial pea protein product, as described in Table 16 of Example 7.

### DETAILED DESCRIPTION OF THE INVENTION

The present inventors have discovered that the conditions used in the prior art to bleach protein isolates do not significantly reduce the lightness and colour of protein isolates derived from BSG and do not produce a protein isolate from BSG having an ideal flavour for use in food and drink applications. The present inventors theorise that this may be due to the specific chemical composition of BSG and the conditions used to extract protein from BSG, which may involve enzymatic hydrolysis under caustic conditions. As a result, significant innovation and ingenuity was required to arrive at a process that is capable of reducing the colour, flavour and aroma of BSG-derived protein isolates without adversely affecting the taste profile, the amount of protein and the amino acid profile.

With the above in mind, the present invention is a process for isolating a protein isolate from a grain material, the process comprising:
a) subjecting an aqueous slurry of the grain material to enzymatic protein hydrolysis to produce a liquid protein stream;
b) removing solids from the liquid protein stream;
c) subjecting the liquid protein stream to one or more filtration steps;
d) processing the liquid protein stream to produce the protein isolate;
   wherein the process further comprises, either during or after step (c), a step of treating the liquid protein stream with a bleaching agent at a temperature of at least 50° C. and a pH of at least 5.

The grain material of the present invention may be brewer's spent grain, barley, barley malt, rice, corn and combinations thereof. Preferably, the grain material is brewer's spent grain.

“Brewer's spent grain” (BSG) is a by-product of the brewing industry following the mashing step. At this point of the brewing process, the soluble fraction (known as ‘wort’) is taken forward for further brewing steps while the insoluble fraction is removed. This insoluble fraction is brewer's spent grain. The brewer's spent grain used in the process of the present invention is preferably obtained after brewing with grains comprising barley and, optionally, one or more other grains or other starchy materials, for example rice, oats, wheat, corn, sorghum, cassava and/or millet, particularly rice, corn, sorghum and/or cassava, more particularly rice and/or corn. It is most preferred that the brewer's spent grain is obtained after brewing with barley or a mixture of barley and rice or corn, preferably rice.

According to the above, the brewer's spent grain may comprise 100% spent barley. Optionally, the brewer's spent grain may comprise from 20% to 100% spent barley by weight of the brewer's spent grain, preferably from 45% to 70% by weight, for example 45%, 50%, 55%, 60%, 65%, or 70% spent barley by weight of the brewer's spent grain. Where the brewer's spent grain is a blend of spent barley and spent rice or spent corn, the spent rice or the spent corn may be present in an amount of from 0% to 80% by weight of the brewer's spent grain, preferably from 30% to 55%, for example 30%, 35%, 40%, 45%, 50% or 55% by weight of the brewer's spent grain.

The colour of a material can be described by the CIELAB colour space (or L*a*b* colour space), defined by the International Commission on Illumination (CIE). It expresses colour as three values: L* for perceptual lightness and a* and b* for the four unique colours of human vision: red, green, blue and yellow. An L* value 0 yields black and an L* value of 100 indicates diffuse white. The a* value determines the material's position between red and green, where negative values indicate green and positive values indicate red, and its b* value represents its position between yellow and blue, where negative values indicate blue and positive values indicate yellow. For the present invention, the L* score provides the best indicator of the colour of the product and its suitability for mixing with other ingredients in foods and beverages and so this value will be referred to primarily.

The brewer's spent grain starting material may have an L* score of from 10 to 60 in solution at 10% dry matter, as measured by the CIELAB method. Optionally, the brewer's spent grain may have an L* score of from 30 to 50, for example 30, 35, 40, 45, or 50 in solution at 10% dry matter. The brewer's spent grain of the present invention may have an a* score of from 5 to 50 in solution at 10% dry matter, as measured by the CIELAB method. Optionally, the brewer's spent grain may an a* score of from 20 to 40, for example 20, 25, 30, 35, or 40 in solution at 10% dry matter. The brewer's spent grain of the present invention may have a b* score of from 40 to 90 in solution at 10% dry matter, as measured by the CIELAB method. Optionally, the brewer's spent grain may a b* score of from 50 to 80, for example 50, 55, 60, 65, 70, 75, or 80 in solution at 10% dry matter. Accordingly, the brewer's spent grain is typically a dark red/brown colour in solution.

The brewer's spent grain starting material may have an L* score of from 30 to 70, preferably from 40 to 60, for example 40, 45, 50, 55, or 60, as a solid measured by the CIELAB method in reflectance mode. The brewer's spent grain of the present invention may have an a* score of from −10 to 20, preferably 0 to 10, for example 0, 1, 2, 3, 4, 5, 6, 7, 8, 9, or 10, as a solid measured by the CIELAB method in reflectance mode. The brewer's spent grain of the present invention may have a b* score of from 0 to 40, preferably 10 to 30, for example 10, 15, 20, 25, or 30, as a solid measured by the CIELAB method in reflectance mode.

The aqueous slurry is formed by mixing the grain material and water. The ratio of water to grain material (dry matter weight) in the aqueous slurry is preferably from 8:1 to 12:1, preferably from 10:1 to 11:1. The aqueous slurry is preferably formed in a jacketed, mixed tank, preferably with heating means.

The aqueous slurry is subjected to enzymatic protein hydrolysis to produce a liquid protein stream. If desired, the grain material may be subjected to particle size reduction before and/or during this step. Any suitable size reduction technique may be used, for example milling.

Prior to enzymatic protein hydrolysis, the aqueous slurry is preferably subjected to enzymatic starch hydrolysis. The enzymatic starch hydrolysis preferably comprises treatment with a glucoamylase enzyme. Suitable glucoamylase enzymes include those used in the brewing industry and may be obtained from EDC (Enzyme Development Corporation, New York) or Novozymes, for example.

The enzymatic starch hydrolysis is preferably carried out at the natural pH of the aqueous slurry. The pH may be, for example, from about 4.5 to about 6.5 (for example 4.5, 5, 5.5, 6 or 6.5, or any intermediate value).

The enzymatic starch hydrolysis is preferably carried out at a temperature of from about 50° C. to about 65° C. (for example 50, 51, 52, 53, 54, 55, 56, 57, 58, 59, 60, 61, 62, 63 or 65° C., or any intermediate temperature).

The enzymatic starch hydrolysis is preferably carried out for a period of at least about 15 minutes, preferably at least about 20 minutes, and up to about 60 minutes, preferably about 45 minutes. For example, the enzymatic starch hydrolysis may be carried out for a period of 15, 20, 25, 30, 35, 40, 45, 50, 55 or 60 minutes, or any intermediate period.

The enzymatic starch hydrolysis is preferably carried out until at least about 90% by weight, preferably at least about 95% by weight, of the initial starch content has been hydrolysed to sugars (i.e. to glucose and/or to other water-soluble saccharides, including di-saccharides and other short-chain oligosaccharides).

The enzymatic protein hydrolysis preferably comprises treatment with a protease enzyme. The protease enzyme is preferably a food grade protease enzyme, preferably a serine protease. It is preferably an alkaline protease, preferably an endopeptidase, preferably a serine endopeptidase. Suitable protease enzymes may be obtained from Novozymes or EDC (Enzyme Development Corporation, New York), for example.

The enzymatic protein hydrolysis is preferably carried out at a pH of from about 7 to about 10 (for example 7, 7.5, 8, 8.5, 9, 9.5, or any intermediate value), preferably at a pH of about 9. The target pH can be achieved by the addition of an alkali such as sodium and/or potassium hydroxide prior to the treatment with the enzyme.

The enzymatic protein hydrolysis is preferably carried out at a temperature of from about 50° C. to about 75° C. (for example 50, 51, 52, 53, 54, 55, 56, 57, 58, 59, 60, 61, 62, 63, 64, 65, 66, 67, 68, 69, 70, 71, 72, 73, 74 or 75° C., or any intermediate temperature), preferably about 55° C. to about 68° C., preferably about 55° C. to about 65° C.

The enzymatic protein hydrolysis is preferably carried out for a period of at least about 15 minutes, preferably at least about 20 minutes, and up to about 80 minutes, preferably about 60 minutes. For example, the enzymatic protein hydrolysis may be carried out for a period of 15, 20, 25, 30, 35, 40, 45, 50, 55, 60, 65, 70, 75 or 80 minutes, or any intermediate period.

The enzymatic protein hydrolysis is preferably carried out until a degree of hydrolysis (dH) of between 1 and 10 (for example 1, 2, 3, 4, 5, 6, 7, 8, 9 or 10, or any intermediate value) has been reached, preferably until a dH of between 4 and 8 has been reached. As used herein, dH may be determined using the pH-stat method, by adding alkali (e.g. NaOH) and applying the following formula:

$$dH = \frac{( B \times {N}_{B} )}{( α \times {h}_{tot} \times {M}_{p} )} \times 100 wt \%$$

where B is the volume of alkali (mL) consumed, NB is the normality of the alkali, α is the average degree of dissociation of amino acids (0.93 is typically used herein), hₜₒₜ is the total peptide bond content (or amino acid content) in 1 g of protein (meq/g; 9 meq/g is typically used herein) and M_{P} is the mass of the protein present (g).

The enzymatic starch hydrolysis (if carried out) and the enzymatic protein hydrolysis preferably take place in the jacketed, mixed tank in which the aqueous slurry is formed.

Subsequent to enzymatic protein hydrolysis, the enzyme(s) is/are preferably deactivated by increasing the temperature, for example to about 75 to about 90° C. (for example about 75, 76, 77, 78, 79, 80, 81, 82, 83, 84, 85, 86, 87, 88, 89 or 90° C., or any intermediate temperature), preferably to about 80° C., for up to about 35 minutes, for example up to about 25 minutes, for example up to about 10, 15, 20 or 25 minutes, or for any intermediate period of time.

Subsequent to enzymatic protein hydrolysis, solids are removed from the liquid protein stream. The removal of solids preferably takes place by decantation, preferably using decantation centrifuges. Pressure may be applied to the solids in order to maximise the recovery of liquid protein stream, for example using a screw press.

The solids removed from the liquid protein stream are preferably washed with water and the resulting wash water is then combined with the liquid protein stream, again to maximise recovery of proteins.

The solids removed from the liquid protein stream may be further processed to provide a fibre product.

The liquid protein stream is then subjected to one or more filtration steps, during which a step of treating with a bleaching agent at a temperature of at least 50° C. and a pH of at least 5 is performed.

### Bleaching Conditions

Bleaching is a process used to remove colour from, or whiten, a product. In the present invention, the bleaching agent may be an oxidising agent or a reducing agent. More specifically, the bleaching agent may be one or more selected from the group consisting of a peroxide-based bleaching agent, a chlorine-based bleaching agent, a nitrogen-based bleaching agent, and a sulfur-based bleaching agent. The colour removal is accompanied by an increase in the L* score of the product. A decrease in its a* score, and/or an increase in its b* score may also be observed.

Where the bleaching agent is a peroxide-based bleaching agent, the peroxide-based bleaching agent may be one or more selected from the group consisting of:
hydrogen peroxide;
a peroxide salt, preferably wherein the peroxide salt is calcium peroxide;
an organic peroxide, preferably wherein the organic peroxide is benzoyl peroxide;
a peroxide adduct, preferably wherein the peroxide adduct is sodium percarbonate or urea hydrogen peroxide;
a perborate salt, preferably wherein the perborate salt is sodium perborate;
a persulfate salt, preferably wherein the persulfate salt is sodium persulfate;
peracetic acid; and
a permanganate salt, preferably wherein the permanganate salt is potassium permanganate. Preferably, the peroxide-based bleaching agent may be one or more selected from the group consisting of hydrogen peroxide, benzoyl peroxide, or urea hydrogen peroxide.

Where the bleaching agent is a chlorine-based bleaching agent, it may be one or more selected from the group consisting of chlorine, chlorine dioxide, and a chlorite salt, preferably wherein the chlorite salt is sodium hypochlorite.

Where the bleaching agent is a nitrogen-based bleaching agent, the nitrogen-based bleaching agent may be azodicarbonamide or nitrogen dioxide.

Where the bleaching agent is a sulfur-based bleaching agent, the sulfur-based bleaching agent may be one or more selected from the group consisting of sulfur dioxide, a dithionite salt, preferably wherein the dithionite salt is sodium dithionite, and a sulfite salt, preferably wherein the sulfite salt is one or more selected from the group consisting of ammonium bisulfite, magnesium bisulfite, potassium bisulfite, sodium bisulfite potassium metabisulfite and sodium metabisulfite. Preferably, the sulfur-based bleaching agent is sodium bisulfite potassium metabisulfite or sodium metabisulfite.

In preferred embodiments, the bleaching agent is one or more selected from the group consisting of sodium metabisulfite, potassium metabisulfite, benzoyl hydrogen peroxide, urea hydrogen peroxide, and hydrogen peroxide, preferably wherein the bleaching agent is hydrogen peroxide. The hydrogen peroxide may be provided at a concentration of from 20 to 45% (w/w) in aqueous solution, for example 35% (w/w) in aqueous solution.

The amount of bleaching agent used in the bleaching step may be at least 0.25 moles of bleaching agent per kilogram of protein (mol/kg protein) to be bleached as determined by AOAC 990.03 or AOAC 992.15. Preferably the amount of bleaching agent is from 0.5 to 50 mol/kg protein, more preferably 1 to 25 mol/kg, more preferably from 1.5 to 6 mol/kg of protein, more preferably 2.5 to 5 mol/kg of protein, for example 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5 mol/kg of protein, or any intermediate value. In certain embodiments, the amount of bleaching agent is from 2.5 to 50 mol/kg protein, for example from 2.5 to 25 mol/kg protein.

The amount of bleaching agent used in the bleaching step may also be described in grams of bleaching agent per kilogram of protein to be bleached (g/kg protein) as determined by AOAC 990.03 or AOAC 992.15. Accordingly, the amount of bleaching agent may be at least 10 g/kg of protein, preferably from 17.5 to 1750 g/kg of protein, preferably from 35 to 875 g/kg, preferably from 52.5 g/kg protein to 210 g/kg protein, more preferably from 85 to 175 g/kg of protein, more preferably to 110 to 150 g/kg protein for example 110, 115, 120, 125, 130, 135, 140, 145, or 150 g/kg, of protein, or any intermediate value.

As mentioned above, the bleaching agent may be added as a dilute solution, which may be a solution in water at from 20 to 45% w/w, preferably 30 to 40% w/w, more preferably 35% w/w. As a dilute solution, the bleaching agent may be added in an amount of at least 10 grams of bleaching agent per kilogram of protein (g/kg protein) as determined by AOAC 990.03 or AOAC 992.15, preferably from 17.5 to 1750 g/kg of protein, preferably from 50 to 750 g/kg of protein, more preferably from 250 g/kg to 500 g/kg of protein, more preferably 325 to 425 g/kg of protein, for example 325, 330, 335, 340, 345, 350, 355, 360, 365, 370, 375, 380, 385, 390, 395, 400, 405, 410, 415, 420 or 425 g/kg or protein.

The temperature during the step of bleaching may be from 50 to 100° C., preferably from 70 to 98° C., more preferably from 80 to 95° C., for example 80, 85, 86, 87, 88, 89, 90, 91, 92, 93, 94 or 95° C. High temperatures (i.e. 80° C. and above) are preferred to reduce the timeframe over which bleaching takes place.

The pH during the step of treating the liquid protein stream with a bleaching agent can be important for the present invention because a low pH may cause precipitation of the proteinaceous material. The pH during the bleaching may be from 5 to 10, preferably 6 to 9.5, more preferably 7 to 8. The pH can be adjusted by the addition of acid or alkali. It is preferred that the pH be maintained at a particular value during bleaching because the pH may reduce as the bleaching step progresses, causing precipitation of the protein. Accordingly, the pH during the bleaching step may be maintained at a value of at least 5, preferably wherein the pH is maintained at a value of between 5 and 10, more preferably between 6 and 9.5, more preferably between 7 and 7.5. The pH may be maintained by the addition of an alkaline agent, wherein the alkaline agent is sodium hydroxide or potassium hydroxide. The alkaline agent may be added during the bleaching step as a 2M aqueous solution in order to maintain the pH at a particular value.

The present inventors have aimed to provide an efficient bleaching process that will readily fit in to their existing processes. Accordingly, the step of treating the liquid protein stream with a bleaching agent is performed for up to 5 hours, preferably from 5 minutes to 5 hours, more preferably from 10 minutes to 3 hours, more preferably from 15 minutes to 1 hour, more preferably from 20 to 45 minutes.

The protein concentration as determined by AOAC 990.03 or AOAC 992.15 in the liquid protein stream during the step of treating the liquid protein stream with a bleaching agent may be from 0.1 to 40% by weight, preferably from 0.5 to 15% by weight of the liquid protein stream, more preferably from 1 to 20% by weight, more preferably from 2 to 15%. The present inventors have discovered that this range is preferred because if the concentration of protein is too high during the bleaching step, overfoaming can occur which can cause problems with the subsequent processing of the liquid protein stream.

In order to achieve the desired protein concentration, it may be necessary to concentrate or dilute the liquid protein stream. In other words, there may be a step of concentrating or diluting the liquid protein stream before the step of treating with a bleaching agent to provide a concentrated or diluted liquid protein stream. Concentrating may be achieved by any method known to the skilled person, for example by one or more selected from the group consisting of filtration, preferably nanofiltration, centrifugation, dewatering, and evaporation. Diluting may be achieved by the addition of water.

The present inventors have discovered that the following conditions for treating the liquid protein stream with a bleaching agent, which form a particularly preferred embodiment because they provide a highly effective reduction in colour and flavour/aroma over a practical timeframe, may be used:
an amount of bleaching agent of from 2.5 to 50, for example, from 2.5 to 5 moles of bleaching agent per kilogram of protein or of from 85 to 175 grams of bleaching agent per kilogram of protein;
a pH of from 7 to 8, which may be maintained in this range during the step of bleaching preferably by the addition of alkali;
a temperature of from 80 to 95° C.;
a time of from 20 to 45 minutes; and,
a protein concentration of from 1 to 20% by weight of the liquid protein stream.

### Bleaching Process

A further important feature of the present invention is the point of the process at which the step of treating the liquid protein stream with a bleaching agent is performed, which is during or after step (c).

The step of treating the liquid protein stream with a bleaching agent may be performed during step (c), i.e. the step of subjecting the liquid protein stream to one or more filtration steps. Step c) preferably comprises at least one nanofiltration step. More preferably the filtration steps may include a microfiltration step and one or more nanofiltration steps and the step of treating the liquid protein stream with a bleaching agent may be performed before the one or more nanofiltration steps.

The microfiltration step obtains a microfiltration permeate comprising protein and a microfiltration retentate. The microfiltration is preferably carried out using a ceramic microfiltration membrane. It has been surprisingly found that ceramic microfiltration membranes are more effective than polymeric membranes in the process of the present invention.

The microfiltration is preferably carried out using a microfiltration membrane having a pore size of from 0.03 to 0.5 μm (for example 0.05, 0.1, 0.15, 0.2, 0.25, 0.3, 0.35, 0.4, 0.45 or 0.5 μm, or any intermediate value), preferably from 0.03 to 0.25 μm, preferably from 0.05 to 0.2 μm, preferably from 0.07 to 0.13 μm (for example 0.07, 0.08, 0.09, 0.10, 0.11, 0.12 or 0.13 μm, or any intermediate value). Suitable microfiltration membranes may be obtained from Pall Corporation. The microfiltration preferably comprises a diafiltration step.

The microfiltration permeate may be subjected to nanofiltration at an applied pressure of from 1.0 bar (100 kPa) to 8.0 bar (800 kPa)) to obtain a nanofiltration permeate and a nanofiltration retentate comprising protein. Applied pressure is a well-known concept in the field of filtration and relates to the pressure at which the feed is fed to the filtration membrane. It is typically controlled by a feed pump and regulated by pressure sensors to ensure that a constant target feed pressure is maintained. The present inventors have found that, by carrying out nanofiltration at a much lower applied pressure of from 1.0 bar (100 kPa) to 8.0 bar (800 kPa), a protein powder having a more favorable taste and solubility profile can be produced.

The nanofiltration may be carried out at an applied pressure of from 1.0 bar (100 kPa), preferably from 1.3 bar (130 kPa), up to 3, 3.5, 4, 4.5, 5, 5.5, 6, 6.5, 7, 7.5 or 8 bar (up to 300, 350, 400, 450, 500, 550, 600, 650, 700, 750 of 800 kPa), or any intermediate value. The nanofiltration is preferably carried out at an applied pressure of from 1.3 bar (130 kPa) to 5.0 bar (500 kPa), preferably from 1.3 bar (130 kPa) to 4.0 bar (400 kPa), for example at an applied pressure of 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0 bar (130, 140, 150, 160, 170, 180, 190, 200, 210, 220, 230, 240, 250, 260, 270, 280, 290, 300, 310, 320, 330, 340, 350, 360, 370, 380, 390 or 400 kPa), or any intermediate value.

The nanofiltration is more preferably carried out at an applied pressure of from 1.3 bar (130 kPa) to 3.3 bar (330 kPa), preferably from 1.4 bar (140 kPa) to 3.2 bar (320 kPa), preferably from 1.5 bar (150 kPa) to 3 bar (300 kPa). For example, nanofiltration may be carried out at an applied pressure of 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2 or 3.3 bar (130, 140, 150, 160, 170, 180, 190, 200, 210, 220, 230, 240, 250, 260, 270, 280, 290, 300, 310, 320 or 330 kPa), or any intermediate value.

The nanofiltration is preferably carried out using a nanofiltration membrane having a molecular weight cut-off (MWCO) of from 500 to 2,000 Da, preferably from 800 to 2,000 Da, preferably from 800 to 1,200 Da. For example, nanofiltration may be carried out using a nanofiltration membrane having a molecular weight cut-off (MWCO) of 500, 600, 700, 800, 900, 1,000, 1,100, 1,200, 1,300, 1,400, 1,500, 1,600, 1,700, 1,800, 1,900 or 2,000 Da, or any intermediate value. Suitable microfiltration membranes may be obtained from MICRODYN-NADIR.

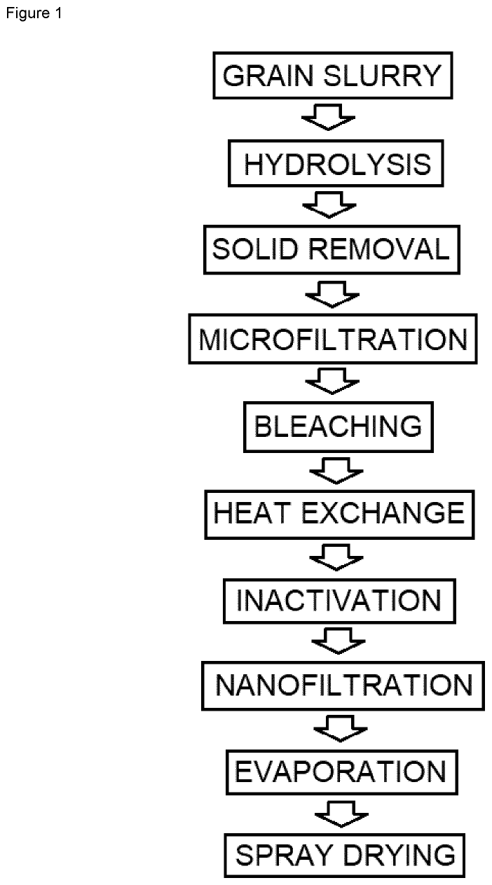

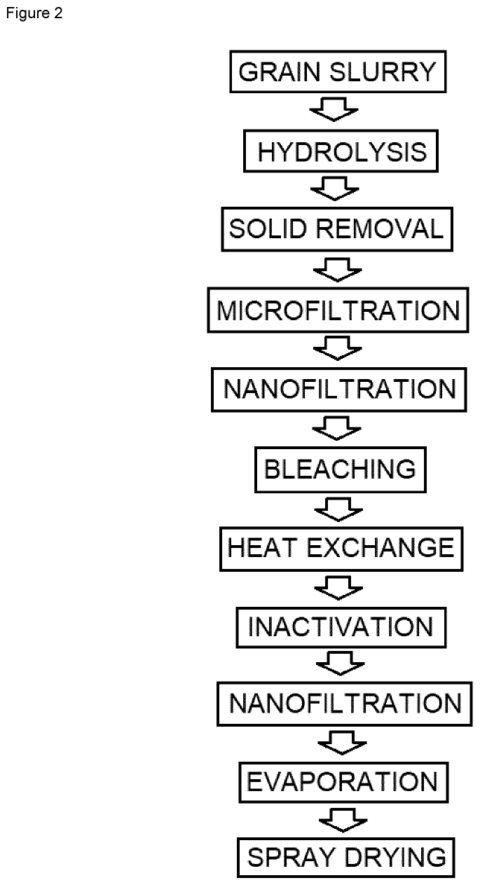

The step of treating the liquid protein stream with a bleaching agent is preferably carried out by diverting the liquid protein stream to a jacketed tank with heating means and adjusting the conditions to the bleaching conditions described hereinabove. The step of treating with a bleaching agent may be performed batch-wise. The step of treating with a bleaching agent may be performed on the microfiltration permeate between the microfiltration step and the one or more nanofiltration steps. In this embodiment, there is preferably one nanofiltration step. Alternatively, the step of treating with a bleaching agent may be performed on the nanofiltration retentate between two nanofiltration steps, i.e. the filtration steps include a microfiltration step and at least two nanofiltration steps and the bleaching step is performed on the nanofiltration retentate between the two nanofiltration steps. Specific versions of these two embodiments are illustrated schematically in FIGS. 1 and 2 respectively.

When incorporating the step of treating the liquid protein stream with a bleaching agent into step c), the step of subjecting the liquid protein stream to one or more filtration steps may comprise:
c1) subjecting the liquid protein stream to microfiltration to obtain a microfiltration permeate comprising protein and a microfiltration retentate;
c2) subjecting the microfiltration permeate to the step of treating with a bleaching agent to provide a bleached microfiltration permeate; and,
c3) subjecting the bleached microfiltration permeate to nanofiltration to obtain a nanofiltration permeate and a nanofiltration retentate comprising protein;
   and, step d) may comprise:
d) processing the nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1) subjecting the liquid protein stream to microfiltration to obtain a microfiltration permeate comprising protein and a microfiltration retentate;
c2) subjecting the microfiltration permeate to a step of treating with a bleaching agent to provide a bleached microfiltration permeate; and,
c3) subjecting the bleached microfiltration permeate to nanofiltration to obtain a nanofiltration permeate and a nanofiltration retentate comprising protein; and,
d processing the nanofiltration retentate to produce the protein isolate;
   wherein the step of treating with a bleaching agent comprises treatment at a temperature of at least 50° C. and a pH of at least 5.

The present inventors have found that bleaching the microfiltration permeate is particularly advantageous. This is because any subsequent filtration steps, such as the nanofiltration step described above, may filter out by-products of the bleaching process (and the by-products of any subsequent process used to inactivate the bleaching agent that may be performed), such as salts and small peptide chains. The protein isolate may be purer and flavour off-notes (in particular bitter notes) in the protein isolate may be removed. The bleaching step may be performed under any of the conditions described hereinabove, but preferably the bleaching conditions of the particularly preferred embodiment.

The microfiltration permeate prior to the step of bleaching may have an L* score of less than 70 in aqueous solution at 1.28% protein by weight, preferably from 20 to 70, more preferably from 45 to 65, in aqueous solution at 1.28% protein by weight as measured by the CIELAB method. The a* score of the microfiltration permeate may be from 20 to 50, preferably from 30 to 40 in aqueous solution at 1.28% protein by weight as measured by the CIELAB method. The b* score of the microfiltration permeate may be from 40 to 80, preferably from 55 to 75 in aqueous solution at 1.28% protein by weight as measured by the CIELAB method.

The bleached microfiltration permeate, i.e. the microfiltration permeate after the step of bleaching, may have an L* score of at least 60, preferably 70 to 100, more preferably 75 to 98 in aqueous solution at 1.28% protein by weight, as measured by the CIELAB method. The a* score of the bleached microfiltration permeate may be from −10 to +10, preferably from −5 to 0 in aqueous solution at 1.28% protein by weight as measured by the CIELAB method. The b* score of the bleached microfiltration permeate may be from 20 to 60, preferably from 30 to 50 in aqueous solution at 1.28% protein by weight as measured by the CIELAB method.

In an alternative embodiment, the step of treating the liquid protein stream with a bleaching agent may be performed between two nanofiltration steps. In this embodiment, the process may further comprise the following steps:
c1′) subjecting the liquid protein stream to microfiltration to obtain a microfiltration permeate comprising protein and a microfiltration retentate; and,
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate comprising protein; and
c4′) subjecting the bleached nanofiltration retentate to nanofiltration to obtain a second nanofiltration permeate and a second nanofiltration retentate comprising protein;
and, wherein step d) comprises:
d) processing the second nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1′) subjecting the liquid protein stream to microfiltration to obtain a microfiltration permeate comprising protein and a microfiltration retentate; and,
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate comprising protein; and
c4′) subjecting the bleached nanofiltration retentate to nanofiltration to obtain a second nanofiltration permeate and a second nanofiltration retentate comprising protein;
d) processing the second nanofiltration retentate to produce the protein isolate;
wherein the step of treating with a bleaching agent comprises treatment at a temperature of at least 50° C. and a pH of at least 5.

The present inventors have discovered that the above process is particularly advantageous because the subsequent nanofiltration step may filter out by-products of the bleaching process (and the by-products of any subsequent process used to inactivate the bleaching agent that may be performed), such as salts and small peptide chains. As a consequence, the protein isolate may be purer and flavour off-notes (in particular bitter notes) in the protein isolate may be removed. The bleaching step may be performed under any of the conditions described hereinabove, but preferably the bleaching conditions of the particularly preferred embodiment.

Preferably, prior to subjecting the bleached nanofiltration retentate to nanofiltration, the bleached nanofiltration retentate is diluted to a protein concentration of from 0.1 to 10% by weight of the bleached nanofiltration retentate, preferably from 1% to 5%, more preferably from 2% to 4%, more preferably 3% by weight of the bleached nanofiltration retentate. The present inventors have discovered that doing so improves the removal of off-notes from the protein isolate, thus improving its flavour and aroma. Preferably, subjecting the bleached nanofiltration retentate to nanofiltration comprises diafiltration.

In addition, the step of treating the liquid protein stream with a bleaching agent may be performed after step c), i.e. after the step of subjecting the liquid protein stream to one or more filtration steps. That is, the bleaching step may be performed after filtration has completed. These filtration steps may include a microfiltration step and one or more nanofiltration steps.

In this embodiment, the process may further comprise the following steps:
c1′) subjecting the liquid protein stream to microfiltration to obtain a microfiltration permeate comprising protein and a microfiltration retentate; and,
c2) subjecting the microfiltration permeate to nanofiltration to obtain a nanofiltration permeate and a nanofiltration retentate comprising protein;
d1′) subjecting the nanofiltration retentate to the step of treating with a bleaching agent to provide a bleached nanofiltration retentate; and, wherein step d) comprises:
d) processing the bleached nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1) subjecting the liquid protein stream to microfiltration to obtain a microfiltration permeate comprising protein and a microfiltration retentate; and,
c2′) subjecting the microfiltration permeate to nanofiltration to obtain a nanofiltration permeate and a nanofiltration retentate comprising protein;
d1′) subjecting the nanofiltration retentate to the step of treating with a bleaching agent to provide a bleached nanofiltration retentate; and, wherein step d) comprises:
d) processing the bleached nanofiltration retentate to produce the protein isolate;
wherein the step of treating with a bleaching agent comprises treatment at a temperature of at least 50° C. and a pH of at least 5.

According to the above, the step of bleaching may be performed on a nanofiltration retentate. The present inventors have found that bleaching at this stage of the process is advantageous because the nanofiltration retentate is concentrated and highly pure, which improves the efficiency of the bleaching step. This advantage also applies to the embodiment wherein bleaching is performed on the nanofiltration retentate between two nanofiltration steps. The bleaching step may be performed under any of the conditions described hereinabove, but and preferably the bleaching conditions of the particularly preferred embodiment.

The nanofiltration retentate prior to the step of bleaching may have an L* score of less than 50 in aqueous solution at 5% protein by weight, preferably from 5 to 40, more preferably from 10 to 30, in aqueous solution at 5% protein by weight as measured by the CIELAB method. The a* score of the nanofiltration retentate may be from 20 to 50, preferably from 30 to 40 in aqueous solution at 5% protein by weight as measured by the CIELAB method. The b* score of the microfiltration permeate may be from 20 to 60, preferably from 30 to 40 in aqueous solution at 5% protein by weight as measured by the CIELAB method.

The bleached nanofiltration retentate may have an L* score of at least 60, preferably 70 to 100, more preferably 75 to 98 in aqueous solution at 5% protein by weight, as measured by the CIELAB method. The a* score of the bleached nanofiltration retentate may be measured and may be from −10 to +10, preferably from −5 to 0 in aqueous solution at 5% protein by weight as measured by the CIELAB method. The b* score of the bleached nanofiltration retentate may be measured and may be from 20 to 60, preferably from 30 to 50 in aqueous solution at 5% protein by weight as measured by the CIELAB method. The above characteristics of the nanofiltration retentate and the bleached nanofiltration retentate also apply to the embodiment wherein bleaching is performed on the nanofiltration retentate between two nanofiltration steps.

Optionally, the nanofiltration retentate may undergo a step of filtration with activated carbon. The activated carbon may be added to the liquid protein stream prior to performing the filtration, or it may be impregnated in the filter that is used for this additional filtration step. Suitable impregnated filters include the Pall Seitz® AKS4 Activated Carbon Sheets. The inclusion of this step may further reduce the overall flavour of the protein isolate. Accordingly, any of the embodiments described herein above or below may include a step of filtration with activated carbon, which is performed prior to, preferably as the step immediately prior to, step (d), (i.e. the step of processing the liquid protein stream to produce the protein isolate).

The nanofiltration retentate is processed to produce the protein isolate. If a step of filtration with activated carbon is performed, then the filtration with activated carbon is performed on the nanofiltration retentate and the permeate from the activated carbon filtration is processed to produce the protein isolate. Processing the nanofiltration retentate (or activated carbon filtration permeate) to produce the protein isolate preferably comprises evaporation to increase the total solids content to a total solids content of from 20 to 55% (for example to 20, 25, 30, 35, 40, 45 or 50%, or any intermediate value), preferably from 25 to 55%, preferably from 35 to 55%, preferably from 45 to 55% by weight (for example to 45, 46, 47, 48, 49, 50, 51, 52, 53, 54 or 55%, or any intermediate value), preferably from 48 to 52% by weight, and then spray drying to produce the protein isolate.

### Bleaching Agent Inactivation

The process may further comprise a step of inactivating the bleaching agent, which may be referred to herein as simply “inactivation”. The bleaching agent inactivation may be achieved by heating or boiling, ascorbic acid treatment, or enzymatic treatment, preferably by enzymatic treatment. The inactivation process may take place in the same jacketed vessel as the step of treating with a bleaching agent. The liquid protein stream may not leave this vessel for further processing until the level of bleaching agent in the stream is less than 1 ppm, preferably less than 0.5 ppm, more preferably when substantially no bleaching agent is present.

When the inactivation is achieved by enzymatic treatment, it may comprise treating with an enzyme composition comprising a catalase. The enzymatic treatment may comprise treatment at a pH of from 4 to 12, a temperature of 40 to 90° C. and an enzyme composition dosage of 0.005 to 1 mL/L, preferably at a pH of 8, a temperature of from 30 to 65° C., and an enzyme composition dosage of from 0.02 to 0.3 mL/L, preferably 0.04 to 0.25 mL/L.

When the inactivation is achieved by ascorbic acid treatment, it may comprise treatment at a temperature of at least 45° C., preferably 65 to 95° C., and an ascorbic acid dosage of at least 0.5 g/L, preferably 0.6 to 1 g/L, for up to 40 minutes, preferably 5 to 15 minutes.

When the inactivation is achieved by heating or boiling, it may comprise treatment at 100° C. for at least 5 minutes, preferably 10 to 60 minutes, more preferably 20 to 50 minutes.

In the embodiment wherein the bleaching process is performed on the microfiltration permeate, the step of inactivating the bleaching agent may occur between the bleaching step and the one or more nanofiltration steps, i.e. between the steps of subjecting the microfiltration permeate to the step of treating with a bleaching agent to provide a bleached microfiltration permeate and the step of subjecting the bleached microfiltration permeate to nanofiltration to obtain a nanofiltration permeate and a nanofiltration retentate comprising protein. In other words, when the bleaching process is performed on the microfiltration permeate, inactivation may be performed on the bleached microfiltration permeate and/or before a subsequent step of nanofiltration. The inventors have discovered that performing the inactivation step at this point is advantageous because the by-products of the inactivation process and unreacted bleaching agent can be filtered out, which may remove off-notes in the protein isolate. In addition, it avoids any degradation of the filtration membranes that may occur as a result of residual bleaching activity.

According to the above, the process may comprise the following steps:
c1) subjecting the liquid protein stream to microfiltration to obtain a microfiltration permeate comprising protein and a microfiltration retentate;
c2) subjecting the microfiltration permeate to the step of treating with a bleaching agent to provide a bleached microfiltration permeate;
c2a) inactivating the bleaching agent;
c3) subjecting the bleached microfiltration permeate to nanofiltration to obtain a nanofiltration permeate and a nanofiltration retentate comprising protein;
   and, wherein step d) comprises:
d) processing the nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1) subjecting the liquid protein stream to microfiltration to obtain a microfiltration permeate comprising protein and a microfiltration retentate;
c2) subjecting the microfiltration permeate to a step of treating with a bleaching agent to provide a bleached microfiltration permeate;
c2a) inactivating the bleaching agent; and,
c3) subjecting the bleached microfiltration permeate to nanofiltration to obtain a nanofiltration permeate and a nanofiltration retentate comprising protein;
and, wherein step d) comprises:
d) processing the nanofiltration retentate to produce the protein isolate;
   wherein the step of treating with a bleaching agent comprises treatment at a temperature of at least 50° C. and a pH of at least 5.

In the embodiment wherein the bleaching process is performed on the nanofiltration retentate, the step of inactivating the bleaching agent may occur between steps c3′) and c4′), that is between the steps of subjecting the nanofiltration retentate to the step of bleaching to provide a bleached nanofiltration retentate; and subjecting the bleached nanofiltration retentate to nanofiltration to obtain a second nanofiltration permeate and a second nanofiltration retentate comprising protein.

According to the above, the process may comprise the following steps:
c1′) subjecting the liquid protein stream to microfiltration to obtain a microfiltration permeate comprising protein and a microfiltration retentate;
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate comprising protein;
c3a′) inactivating the bleaching agent; and,
c4′) subjecting the bleached nanofiltration retentate to nanofiltration to obtain a second nanofiltration permeate and a second nanofiltration retentate comprising protein;
and, wherein step d) comprises:
d) processing the second nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1) subjecting the liquid protein stream to microfiltration to obtain a microfiltration permeate comprising protein and a microfiltration retentate; and,
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate comprising protein;
c3a′) inactivating the bleaching agent; and,
c4′) subjecting the bleached nanofiltration retentate to nanofiltration to obtain a second nanofiltration permeate and a second nanofiltration retentate comprising protein;
and, wherein step d) comprises:
d processing the second nanofiltration retentate to produce the protein isolate;
wherein the step of treating with a bleaching agent comprises treatment at a temperature of at least 50° C. and a pH of at least 5.

In the embodiment wherein the bleaching process is performed on the nanofiltration retentate, the step of inactivating the bleaching agent may occur between steps d1) and d), that is between the steps of subjecting the nanofiltration retentate to the step of bleaching to provide a bleached nanofiltration retentate; and processing the bleached nanofiltration retentate to produce the protein isolate.

According to the above, the process may comprise the following steps:
c1′) subjecting the liquid protein stream to microfiltration to obtain a microfiltration permeate comprising protein and a microfiltration retentate;
c2′) subjecting the microfiltration permeate to nanofiltration to obtain a nanofiltration permeate and a nanofiltration retentate comprising protein;
d1′) subjecting the nanofiltration retentate to the step of treating with a bleaching agent to provide a bleached nanofiltration retentate;
d2′) inactivating the bleaching agent; and, wherein step d) comprises:
d) processing the bleached nanofiltration retentate to produce the protein isolate.

As a result, the process for isolating a protein isolate from a grain material may comprise:
a) subjecting an aqueous slurry of the grain material to enzymatic protein hydrolysis to produce a liquid protein stream;
b) removing solids from the liquid protein stream;
c1) subjecting the liquid protein stream to microfiltration to obtain a microfiltration permeate comprising protein and a microfiltration retentate; and,
c2′) subjecting the microfiltration permeate to nanofiltration to obtain a nanofiltration permeate and a nanofiltration retentate comprising protein;
d1′) subjecting the nanofiltration retentate to a step of treating with a bleaching agent to provide a bleached nanofiltration retentate;
d2′) inactivating the bleaching agent; and, wherein step d) comprises:
d) processing the bleached nanofiltration retentate to produce the protein isolate;
wherein the step of treating with a bleaching agent comprises treatment at a temperature of at least 50° C. and a pH of at least 5.

Between the step of treating with a bleaching agent and step of inactivating the bleaching agent, there may be a step of temperature variation, preferably by a heat exchanger, in order to increase or reduce the temperature of the liquid protein stream to the temperature required for the inactivation process. Preferably, the temperature is reduced to below 60° C., more preferably to between 40° C. and 55° C., in particular when inactivation is performed by enzymatic treatment.

### Protein Isolate

The protein isolate of the present invention has a high protein content. It has a reduced colour and a less pronounced taste compared to the grain starting material and protein isolates produced by the same process but without a step of treating the liquid protein stream with a bleaching agent. The protein isolate is therefore more suited to mixing with other ingredients to provide protein-enriched comestibles because it has a minimal impact on the taste and appearance of the comestible. The protein isolate has a high polyphenol content, but a reduced polyphenol content compared to protein isolates produced by the same process without a step of treating the liquid protein stream with a bleaching agent.

The protein isolate of the present invention may be obtained by or obtainable by the process described hereinabove.

The protein isolate has a protein content (% dry matter by weight) of at least 80%, preferably at least 85% (for example at least 80, 81, 82, 83, 84 or 85%, or any intermediate value), as determined by AOAC 990.03 or AOAC 992.15. The process devised by the present inventors does not affect the protein content of the isolate compared to an isolate produced by the same process but without the bleaching step. Importantly, the process also has no significant impact on the amino acid profile of the protein isolate when compared to an isolate produced by the same process but without the bleaching step, as shown in Table 1 below.

TABLE 1

| | Unbleached sample | Bleached sample |
|---|---|---|
| Amino Acid | (g/100 g) | (g/100 g) |
| Alanine | 4.95 | 4.80 |
| Arginine | 5.41 | 4.93 |
| Aspartic acid | 9.29 | 9.61 |
| Glutamic acid | 23.45 | 26.69 |
| Glycine | 4.47 | 4.33 |
| Histidine | 2.33 | 1.44 |
| Isoleucine | 4.26 | 3.92 |
| Leucine | 7.68 | 7.07 |
| Lysine | 3.99 | 3.42 |
| Phenylalanine | 5.85 | 5.71 |
| Proline | 10.11 | 11.02 |
| Serine | 4.41 | 4.49 |
| Threonine | 3.73 | 3.65 |
| Tyrosine | 4.20 | 3.32 |
| Valine | 5.88 | 5.60 |

The protein isolate typically has an L* score of at least 60, preferably 70 to 100, more preferably 75 to 98 in water at 5% protein by weight, for example 75, 76, 77, 78, 79, 80, 81, 82, 83, 84, 85, 86, 87, 88, 89, 90, 91, 92, 93, 94, 95, 96, 97 or 98, as measured by the CIELAB method. The protein isolate typically has an a* score of −5 to 15 preferably from 0 to 10 in aqueous solution at 5% protein by weight, as measured by the CIELAB method. The protein isolate typically has a b* score of 50 to 80 preferably from 60 to 75 in aqueous solution at 5% protein by weight, as measured by the CIELAB method. Accordingly, the protein isolate of the present invention is a light off-white/yellow colour, which allows it to be readily blended with other ingredients to produce food and beverage products without affecting their appearance.

The L* score may be at least 1.25 times higher, preferably 1.25 to 3.5 times higher, more preferably 1.5 to 3 times higher, than that of a protein isolate isolated by the process described hereinabove without a step of bleaching.

The polyphenol content of a protein isolate derived from BSG by enzymatic hydrolysis without a step of bleaching is around 10-100 times higher than that of other protein isolates derived from plants and animal products (see Table 2 below).

TABLE 2

| Protein isolate | Polyphenol content* (mg/kg) |
|---|---|
| Axiom ® Veg-o-tein P ™ - yellow pea | 954 |
| protein isolate | |
| Glanbia Provon ® 190 - whey protein | 1,360 |
| isolate | |
| DuPont SUPRO ® - soy protein isolate | 1,980 |
| Roquette Naturalys ® - pea protein isolate | 5,910 |
| Unbleached BSG protein isolate | 43,500 |

*as measured by the Folin-Ciocalteu (or gallic acid equivalent) method.

The bleaching process may result in a protein isolate having a reduced polyphenol content compared an unbleached protein isolate isolated from BSG. Accordingly, the step of bleaching may provide a reduction in polyphenol content as measured by the Folin-Ciocalteu method of up to 90% compared with the polyphenol content of a protein isolate produced according to the process without a step of treating the liquid protein stream with a bleaching agent, preferably from 10 to 60%, more preferably from 20 to 40%.

The protein isolate may have a total polyphenol content of between 10,000 and 50,000 mg/kg of the protein isolate as determined by the Folin-Ciocalteu method, preferably 15,000 to 35,000 mg/kg of the protein isolate, more preferably 20,000 to 30,000 mg/kg of the protein isolate as determined by the Folin-Ciocalteu method.

The total polyphenol content of the protein isolate as determined by the Folin-Ciocalteu method may be 40% to 80%, preferably 55% to 75%, that of a protein isolate isolated from a grain material, preferably brewer's spent grain, produced by the process described herein above but without the step of treating the liquid protein stream with a bleaching agent.

The protein isolate may have a solubility in water at a pH of 8 or less of at least 70%, preferably at least 75%, at a protein concentration of 2% dry matter (as determined by the Kjeldahl method using a conversion factor of 6.25). At a pH of at least 5, the solubility in water may be at least 90%, preferably at least 95%, at a protein concentration of 2% dry matter. At a pH of from 2 to 5, the solubility in water may be at least 70%, preferably from 75% to 90%, for example 75, 76, 77, 78, 79, 80, 81, 82, 83, 84, 85, 86, 87, 88, 89, or 90%, at a protein concentration of 2% dry matter. The solubility of the protein isolate means that it is well suited to inclusion in foods and beverages, particularly beverages. The solubility at low pH may make it suitable for inclusion in acidic carbonated beverages.

The protein isolate may have a low viscosity in water at a protein concentration of 5% dry matter (as determined by the Kjeldahl method using a conversion factor of 6.25) of less than 5 centipoise (or mPa·s), preferably from 0.5 to 4 mPa·s, more preferably from 2 to 3.5 mPa·s. At a protein concentration of 10% dry matter, the protein isolate may have a viscosity from 4 to 10 mPa·s, more preferably from 4.5 to 6.5 mPa·s. At a protein concentration of 20% dry matter, the protein isolate may have a viscosity of from 10 to 25 mPa·s, more preferably from 12 to 18 mPa·s. Accordingly, the protein isolate will not add body or viscosity to liquid products in which it is included.

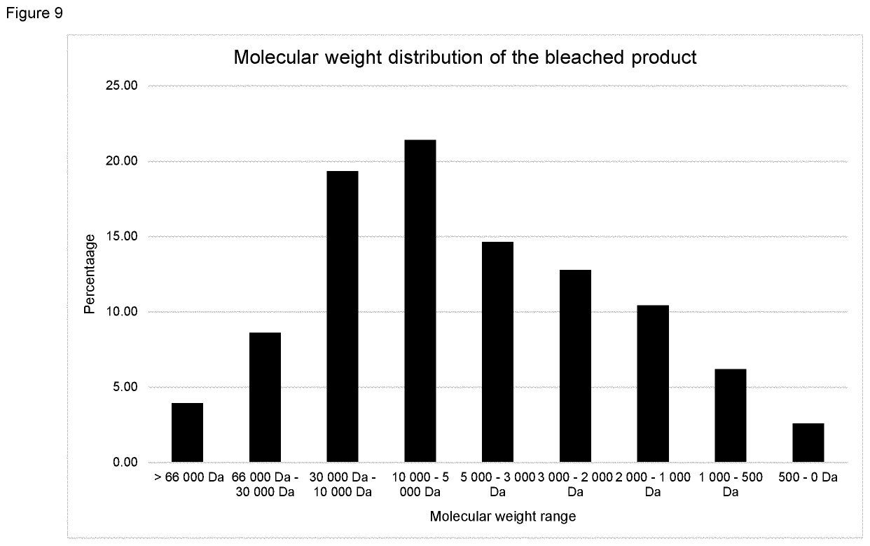

The protein isolate may have a molecular weight distribution as shown in FIG. 9. The majority of the proteinaceous material may have a molecular weight of from 3,000 Da to 30,000 Da, preferably from 5,000 Da to 30,000 Da. For example, the percentage of protein in the protein isolate having a molecular weight of from 3,000 Da to 30,000 Da, preferably from 5,000 Da to 30,000 Da, may be at least 51%, preferably from 51 to 70%, more preferably from 55 to 65%. The protein isolate may have an average molecular weight of 5,000 to 10,000 Da, preferably 5,500 to 8,000 Da, more preferably 6,500 to 7,500 Da, for example 6,500, 6,750, 7,000, 7250, or 7500 Da.

The molecular weight profile of the protein isolate is advantageous in providing the isolate with a desirable taste profile. In this regard, the protein isolate may have a relatively high proportion of protein fragments having a molecular weight of at least 1,000 Da. The percentage of protein in the protein isolate having a molecular weight of at least 1,000 Da is at least 85% by weight of the protein in the protein isolate, preferably from 90 to 98% by weight, for example 90, 92, 94, 96, or 98% by weight, as determined by the Kjeldahl method using a conversion factor of 6.25. Concordantly, the protein isolate contains a low proportion of low molecular weight protein fragments, e.g. 1000 Da or less. For example, the percentage of protein in the protein isolate having a molecular weight of 1000 Da or less may be less than 15% by weight of the protein in the protein isolate, preferably from 5 to 12% by weight, for example 5, 6, 7, 8, 9, 10, 11 or 12% by weight. The percentage of protein in the protein isolate having a molecular weight of 0 to 500 Da is less than 10% by weight of the protein in the protein isolate, preferably from 1 to 7% by weight, for example 1, 2, 3, 4, 5, 6, or 7% by weight. The low proportion of protein fragments having a molecular weight of 1000 Da or less, in particular 500 Da or less, has an advantageous impact on the taste profile of the protein isolate and may reduce bitterness of bitter flavours compared to protein isolates having a higher proportion of protein fragments in these molecular weight ranges.

The protein isolate may have an in vitro digestibility of at least 80%, preferably from 80 to 100%, most preferably 100%.

The protein isolate may comprise substantially no bleaching agent. When the bleaching agent is hydrogen peroxide, the protein isolate may contain substantially no hydrogen peroxide. The protein isolate may have a concentration of hydrogen peroxide of less than 1 ppm, preferably less than 0.5 ppm as measured, more preferably 0 ppm, by Quantofix® Peroxide 100 test strips.

The protein isolate produced by the process preferably has a total solids content of at least 90% by weight, preferably at least 93% by weight (for example at least 90, 91, 92, 93 or 94%, or any intermediate value).

The protein isolate may be used to prepare or be incorporated into food or beverage comprising. The protein isolate may be incorporated into the food or beverage in any amount, such as up to 75% by weight of the food or beverage product, preferably 0.5% to 50% by weight, more preferably 20 to 40% by weight of the food or beverage product without impacting the flavour profile of the food or beverage product. In some embodiments, the food or beverage product is a beverage or pourable food including, ready-to-drink (RTD) beverages, for example, energy drinks, shakes, smoothies, coffee and coffee-based drinks (i.e. latte, mocha, etc.), teas and plant-based milk substitutes. In some embodiments, the protein isolate may be provided as a ready to mix (RTM) powder for preparing beverages or a coffee creamer powder. In other embodiments, the food or beverage product can comprise muscle building supplements including meal replacement bars and workout drinks. In some embodiments, said food or beverage product can comprise meat substitutes including, for example, meat and meat binder replacements and extruded meat substitutes. In some embodiments, the (protein-enhanced) food or beverage product can comprise coatings and/or bindings for granola, nutrition bars and mueslis. In other embodiments, the protein-enhanced food or beverage product can comprise seasonings for the preparation of bases, gravies, soups and sauces. In some embodiments, the (protein-enhanced) food or beverage product comprises baked goods such as, for example, brownies, cakes, cookies, breads, crackers and the like. In yet other embodiments, the (protein-enhanced) food or beverage product can comprise breakfast products including waffles, pancakes, quick breads, pastries and the like. In some embodiments, the protein-enhanced food or beverage product can comprise dairy products such as, for example, yogurts, cheese spreads, cheese based products and the like. In some embodiments, the (protein-enhanced) food or beverage product can comprise cocoa power extender. In some embodiments, the protein-enhanced food or beverage product can comprise chocolates, candies and confections. In some embodiments, the (protein-enhanced) food stuff can comprise carbohydrate based entrees such as pasta (macaroni and cheese), rice and grains. In some embodiments, the protein-enhanced food or beverage product can comprise dips, spreads and toppings (hummus).

Said food or beverage product may be suited for both human and animal consumption. In an embodiment, said composition is suited to be used as pet food or in pet food formulations.

### EXAMPLES

The present invention will now be further exemplified with reference to the following examples. The present invention is in no way limited to the given examples or to the embodiments presented in the figures.

### Folin-Ciocalteu (or Gallic Acid Equivalent) Method

Polyphenol content was determined by the Folin-Ciocalteu method described in ISO 14502:2005.

### CIELAB (or L*a*b*) Colour Measurement

Measurements were taken using a Konica Minolta Bench-top Spectrophotometer CM-5. Liquid samples were taken from the reaction mixture, transferred to a 10 ml cuvette (plastic cell—CM A131, 50×38, optical path 10 mm-0.1 mm thickness front/0.23 mm thickness side) and measured in transmittance mode. Solid samples were measured in reflectance mode.

### Protein Content

Protein content was determined by AOAC 990.03 or AOAC 992.15 using a LECO FP928 protein analyser on a sample (0.1 g of solid material or 1 ml of solution).

### Amino Acid Content

Amino acid content was determined using ISO 13903:2005.

### Solubility Analysis

Solubility was measured as a function of pH and protein concentration according to the following method. A suspension of the sample was prepared at the desired protein concentration at 20° C. and the pH adjusted to the desired value using HCl (1 M) or NaOH (1 M). The samples were centrifuged at 4,000 rpm for 10 minutes. A control sample was prepared at the desired protein concentrations with no pH adjustment (Native). The protein content of the Native sample and the supernatants of the test samples were measured using the Kjeldahl method, conversion factor 6.25. Solubility was calculated according to the below equation:

$$Solubility ( \% ) = \frac{Protein content sample}{Protein content Native} \times 100$$

### Viscosity

Viscosity was measured using an Anton Paar Rheometer MCR102e, using a double gap spindle @ rpm 1/sec at room temperature.

### Molecular Weight Characterisation

Molecular weight analysis was performed using a Thermofisher Vanquish high performance liquid chromatography (HPLC) according to the following method. A sample (200 μL) was injected onto a series of two columns (Superdex® 75 GL (molar mass range 70,000-3,000 Da) and Superdex® 30 GL (molar mass 7,000-100 Da)) using a mobile phase of dipotassium hydrogen phosphate (125 mM) and potassium dihydrogen phosphate (125 mM) at pH 6.8. The flow rate was 0.50 mL/min and the method was run at room temperature for between 90 and 160 mins. Ultraviolet detection was performed at 218 nm.

### Examples of the Bleaching Process

### General Method

Protein isolates were prepared according to the following general method. Brewer's spent grain comprising spent barley and either spent corn or spent rice was received into a jacketed, mixed tank with water to make 10.5:1 water to dry weight ratio. The resulting slurry was heated to 55° C. and treated with a glucoamylase enzyme (EDC Enzeco® glucoamylase) for 45 minutes to hydrolyse the starch. The pH was then raised to 9 using alkali and maintained for 45 minutes.

The mixture was then treated with a food-grade protease enzyme (EDC Enzeco® alkaline protease L-660) for 20 to 60 minutes at 60° C. to hydrolyse the protein component. Thereafter, the enzymes were deactivated by heating the mixture to 80° C. and holding for up to 25 minutes.

The solids were separated from the liquid protein stream by decanting centrifuges. The liquid protein stream was fed into a microfiltration system (0.1 μm membranes; 70 to 80° C.; suitable membranes available from Pall Corporation). The permeate from the microfiltration was processed in a nanofiltration system (MWCO of c. 1000 Da; applied pressure 1.5 to 3 bar; suitable membranes available from MICRODYN-NADIR). The output retentate was then subjected to vacuum evaporation to remove water prior to spray drying.

Bleaching with Hydrogen Peroxide

### Example 1—Bleaching the nanofiltration retentate

The following Examples were prepared from brewer's spent grain comprising spent barley and spent rice using the General method. The spray dried product was dissolved in water to a concentration of 5% protein by weight and treated with hydrogen peroxide (Solvay Interox® ST-35 35% (w/w)) at 66° C. for 300 minutes. The hydrogen peroxide dosages in Tables 1 and 2 below are defined as a multiple of X, where X=50 g of hydrogen peroxide (35% w/w) per kg of protein, i.e. 17.5 g of hydrogen peroxide per kg of protein. This dosage was chosen based on that used to bleach whey protein in Jervis et al, Effect of bleaching whey on sensory and functional properties of 80% whey protein concentrate, J. Dairy Sci., 2012, 95(6), 2848-2862, which uses 5 g of hydrogen peroxide (35% w/w) per kilogram of whey.

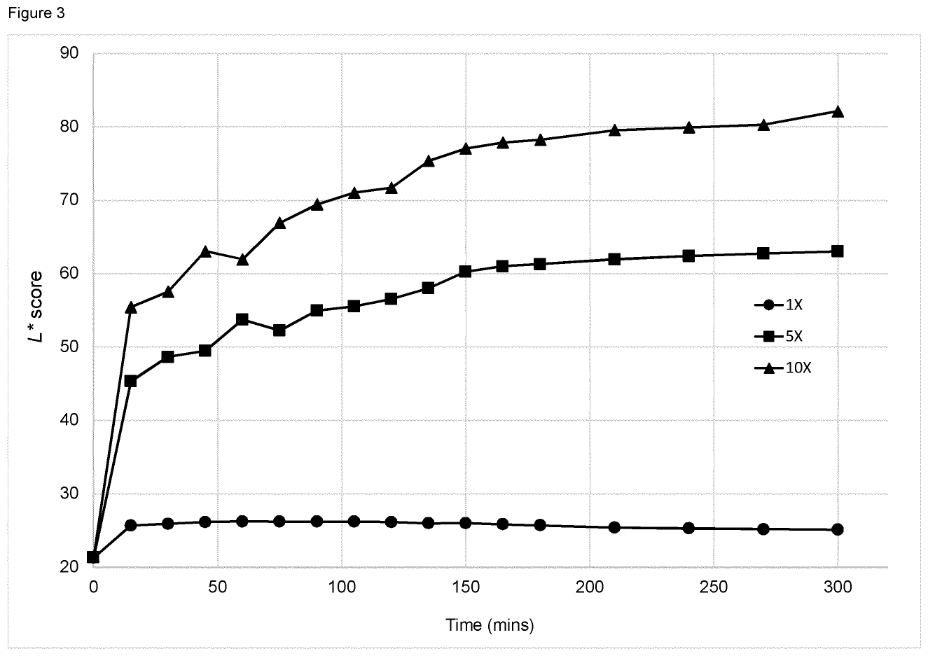

The colour of the solution was measured using the L*a*b method during bleaching. The Lightness (L*) at start and at the end of the treatment time are shown in Table 3 below, while Table 4 provides data for all of the L*a*b* measurements taken, which are illustrated in FIG. 3.

TABLE 3

| H₂O₂ dosage | L* (Start) | L* (End) |
|---|---|---|
| 1X | 21.29 | 25.1 |
| 5X | 21.37 | 63.03 |
| 10X | 21.5 | 82.14 |

TABLE 4

| Time | 1X | | | 5X | | | 10X | | |
|---|---|---|---|---|---|---|---|---|---|
| (min) | L* | a* | b* | L* | a* | b* | L* | a* | b* |
| 0 | 21.29 | 36.1 | 36.58 | 21.37 | 36.14 | 36.64 | 21.5 | 36.16 | 36.84 |
| 15 | 25.67 | 39.78 | 44.03 | 45.35 | 35.97 | 70.71 | 55.45 | 27.98 | 73.03 |
| 30 | 25.9 | 40.03 | 44.34 | 48.66 | 34.08 | 73.3 | 57.55 | 24.02 | 71.42 |
| 45 | 26.15 | 40.2 | 44.87 | 49.47 | 32.56 | 73.16 | 63.05 | 22.06 | 73.69 |
| 60 | 26.23 | 40.27 | 44.98 | 53.75 | 30.94 | 75.56 | 61.95 | 19.91 | 71.09 |
| 75 | 26.21 | 40.28 | 44.97 | 52.26 | 32.3 | 75.27 | 66.92 | 18.74 | 73.51 |
| 90 | 26.2 | 40.28 | 44.9 | 54.98 | 30.36 | 76.13 | 69.44 | 16.84 | 73.31 |
| 105 | 26.2 | 40.34 | 44.93 | 55.55 | 29.89 | 76.29 | 71.04 | 15.89 | 73.34 |
| 120 | 26.13 | 40.4 | 44.84 | 56.52 | 29.05 | 76.5 | 71.72 | 14.61 | 72.35 |
| 135 | 25.97 | 40.3 | 44.56 | 58.02 | 27.13 | 76.61 | 75.37 | 12.4 | 72.35 |
| 150 | 26 | 40.34 | 44.62 | 60.26 | 26.24 | 77.93 | 77.06 | 10.73 | 71.36 |
| 165 | 25.83 | 40.3 | 44.33 | 61 | 25.45 | 77.95 | 77.86 | 10.02 | 70.93 |
| 180 | 25.7 | 40.27 | 44.11 | 61.28 | 25.16 | 77.96 | 78.27 | 9.6 | 70.59 |
| 210 | 25.4 | 40.23 | 43.63 | 61.94 | 24.62 | 78.01 | 79.55 | 8.34 | 69.55 |
| 240 | 25.29 | 40.21 | 43.5 | 62.4 | 24.1 | 77.98 | 79.93 | 8.02 | 69.36 |
| 270 | 25.16 | 40.15 | 43.24 | 62.75 | 23.81 | 78.08 | 80.29 | 7.69 | 69.08 |
| 300 | 25.1 | 40.08 | 43.12 | 63.03 | 23.5 | 78.04 | 82.14 | 6.79 | 68.68 |

These results show that the concentration of hydrogen peroxide suitable to bleach whey protein is not sufficient to significantly reduce the colour/lighten the present protein isolate derived from BSG. Doses of 5X and above are preferred to provide significant bleaching within a practical timeframe.

### Example 2—Bleaching the Microfiltration Permeate

The following Examples were prepared from brewer's spent grain comprising spent barley and spent corn using the General method except that, following microfiltration, the microfiltration permeate was concentrated to 1.28% protein by weight and treated with hydrogen peroxide (Solvay Interox® ST-35 35% (w/w)) under the conditions in Table 5 below. The hydrogen peroxide dosage is defined as a multiple of X, where X=50 g of hydrogen peroxide (35% w/w) per kg of protein, i.e. 17.5 g of hydrogen peroxide per kg of protein. Following the step of treating with a bleaching agent, the bleached microfiltration permeate was subjected to nanofiltration, evaporated and spray dried in accordance with the General method.

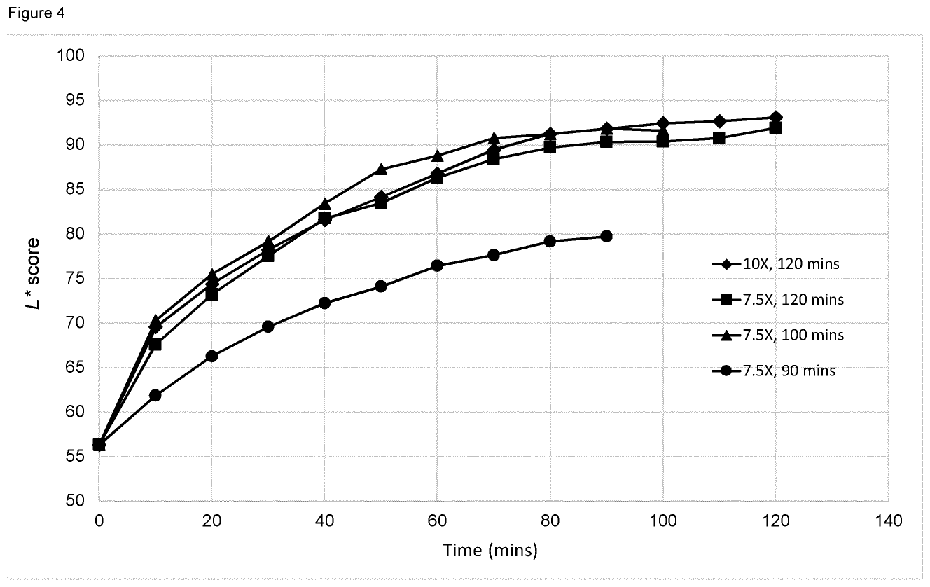

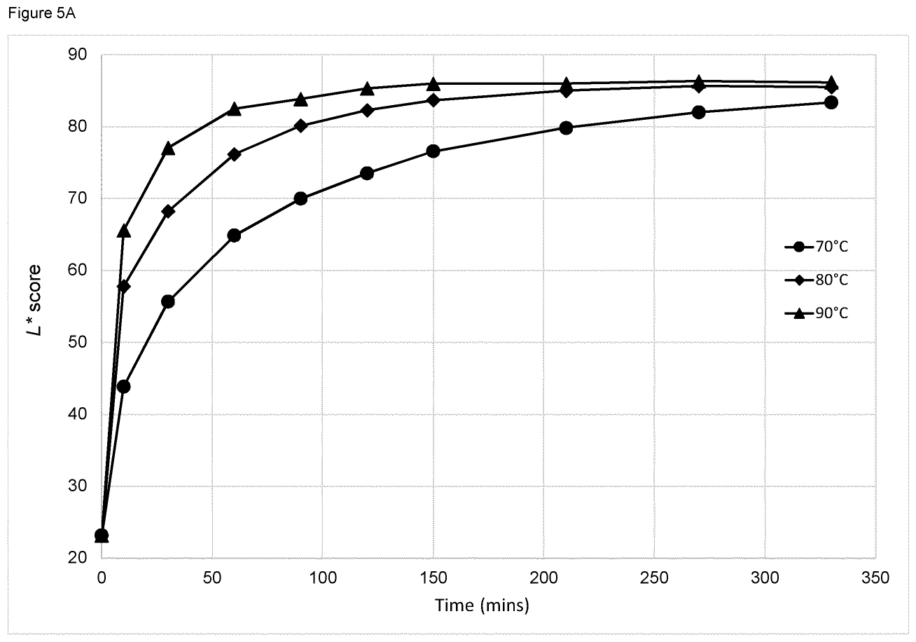

The colour of the solution was measured using the L*a*b method during bleaching. The Lightness (L*) at start and at the end of the treatment time are shown in Table 5 below, while Table 6 provides data for all of the L*a*b* measurements taken, which are illustrated in FIG. 4. The pH was monitored during bleaching and maintained at the stated level by the addition of 2M aqueous KOH.

TABLE 5

| H₂O₂ dosage | Temp (° C) | Time (mins) | pH | L* (Start) | L* (End) |
|---|---|---|---|---|---|
| 10X | 90 | 120 | 7 | 56.34 | 93.09 |
| 7.5X | 90 | 120 | 7 | 56.34 | 91.91 |
| 7.5X | 90 | 100 | 7.5 | 56.34 | 91.62 |
| 7.5X | 80 | 90 | 7 | 56.34 | 79.71 |

TABLE 6

| Time | 10X | | | 7.5X | | | 7.5X | | | 7.5X | | |
|---|---|---|---|---|---|---|---|---|---|---|---|---|
| (min) | L* | a* | b* | L* | a* | b* | L* | a* | b* | L* | a* | b* |
| 0 | 56.34 | 36.38 | 64.47 | 56.34 | 36.38 | 64.47 | 56.34 | 36.38 | 64.47 | 56.34 | 36.38 | 64.47 |
| 10 | 69.57 | 21.04 | 61.73 | 67.59 | 23.21 | 62.52 | 70.3 | 20.06 | 63.76 | 61.86 | 29.7 | 63.73 |
| 20 | 74.37 | 15.56 | 60.19 | 73.22 | 16.68 | 61.43 | 75.49 | 13.96 | 62.1 | 66.26 | 25.05 | 62.83 |
| 30 | 78.24 | 11.04 | 58.33 | 77.53 | 11.68 | 59.57 | 79.18 | 9.15 | 58.13 | 69.58 | 21.22 | 62.4 |
| 40 | 81.59 | 7.15 | 56.17 | 81.75 | 6.63 | 57.95 | 83.4 | 4.64 | 57.98 | 72.23 | 18.19 | 61.35 |
| 50 | 84.15 | 4.16 | 54.83 | 83.51 | 4.25 | 55.92 | 87.3 | 1.12 | 53.92 | 74.09 | 15.97 | 60.62 |
| 60 | 86.78 | 1.9 | 52.98 | 86.33 | 2.14 | 53.47 | 88.8 | −0.34 | 48.82 | 76.42 | 13.2 | 59.78 |
| 70 | 89.46 | −0.28 | 49.94 | 88.4 | 0.66 | 50.9 | 90.77 | −1.56 | 46.39 | 77.63 | 11.89 | 59.32 |
| 80 | 91.23 | −1.64 | 46.37 | 89.71 | −0.48 | 48.24 | 91.2 | −1.9 | 45.02 | 79.16 | 10.01 | 58.15 |
| 90 | 91.81 | −2.27 | 43.75 | 90.34 | −0.99 | 46.52 | 91.84 | −2.27 | 43.22 | 79.71 | 9.28 | 58.64 |
| 100 | 92.42 | −2.71 | 41.28 | 90.38 | −1.37 | 45.56 | 91.62 | −2.32 | 42.82 | | | |
| 110 | 92.65 | −2.81 | 40.74 | 90.76 | −1.56 | 44.5 | | | | | | |
| 120 | 93.09 | −2.95 | 41.45 | 91.91 | −1.97 | 43.71 | | | | | | |

Treating the microfiltration permeate with hydrogen peroxide was able to significantly increase the lightness of the solution compared to the unbleached barley/corn powdered isolate and unbleached barley/corn 5% protein solution. The experiments performed at 90° C. proceeded at a similar rate, while the experiment performed at 80° C. was slower and did not reach as high a lightness value.

### Example 3—Effect of Temperature on the Bleaching Process

The protein isolates in the following Examples were prepared according to the General method from brewer's spent grain comprising spent barley and spent rice. The spray dried product was dissolved in water to a concentration of 5% protein by weight and bleaching with hydrogen peroxide (Solvay Interox® ST-35 35% (w/w)) under the conditions in Table 7 below. The hydrogen peroxide dosage is defined as a multiple of X, where X=50 g of hydrogen peroxide (35% w/w) per kg of protein, i.e. 17.5 g of hydrogen peroxide per kg of protein.

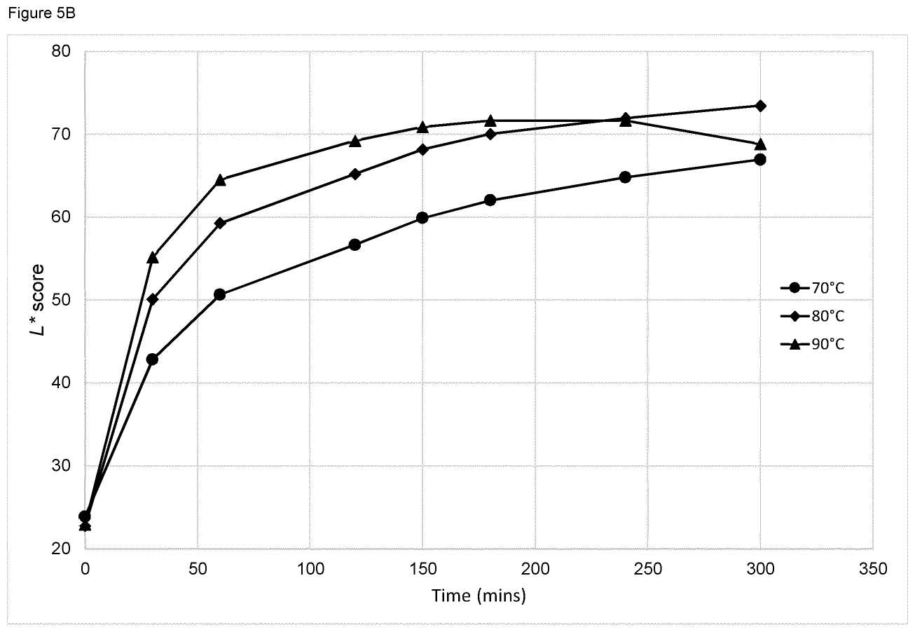

The colour of the solution was measured using the L*a*b method during bleaching. The Lightness (L*) at start and at the end of the treatment time are shown in Tables 7 and 8 below, while Tables 9 and 10 provide data for all of the L*a*b* measurements taken, which are illustrated in FIGS. 5A and 5B.

TABLE 7

| H₂O₂ dosage | Temp (° C.) | Time (mins) | L* (Start) | L* (End) |
|---|---|---|---|---|
| 10X | 70 | 330 | 23.19 | 83.36 |
| 10X | 80 | 330 | 23.19 | 85.53 |
| 10X | 90 | 330 | 23.19 | 86.17 |

TABLE 8

| H₂O₂ dosage | Temp (° C.) | Time (mins) | L* (Start) | L* (End) |
|---|---|---|---|---|
| 5X | 70 | 300 | 23.86 | 66.94 |
| 5X | 80 | 300 | 22.8 | 73.44 |
| 5X | 90 | 300 | 22.93 | 68.82 |

TABLE 9
10X Dosage

| Time | 70° C. | | | 80° C. | | | 90° C. | | |
|---|---|---|---|---|---|---|---|---|---|
| (min) | L* | a* | b* | L* | a* | b* | L* | a* | b* |
| 0 | 23.19 | | | 23.19 | | | 23.19 | | |
| 10 | 43.87 | 34.63 | 67.89 | 57.82 | 27.47 | 74.93 | 65.61 | 21.7 | 76.54 |
| 30 | 55.66 | 29.05 | 73.93 | 68.23 | 19.55 | 76.13 | 77.05 | 12.58 | 74.64 |
| 60 | 64.86 | 21.44 | 74.4 | 76.18 | 12.63 | 73.4 | 82.52 | 7.03 | 69.37 |
| 90 | 69.98 | 16.97 | 73.57 | 80.13 | 8.97 | 70.53 | 83.86 | 5.23 | 67.01 |
| 120 | 73.52 | 14.04 | 72.54 | 82.3 | 6.9 | 68.4 | 85.34 | 4.22 | 65.93 |
| 150 | 76.58 | 11.41 | 70.99 | 83.7 | 5.45 | 66.37 | 85.99 | 3.66 | 65.31 |
| 210 | 79.83 | 8.49 | 68.56 | 85 | 3.96 | 63.94 | 86 | 3.72 | 65.64 |
| 270 | 82.02 | 6.61 | 66.55 | 85.64 | 3.45 | 62.92 | 86.33 | 3.54 | 65.8 |
| 330 | 83.36 | 5.45 | 65.08 | 85.53 | 3.86 | 62.78 | 86.17 | 3.84 | 66.56 |

TABLE 10
5X Dosage

| Time | 70° C. | | | 80° C. | | | 90° C. | | |
|---|---|---|---|---|---|---|---|---|---|
| (min) | L* | a* | b* | L* | a* | b* | L* | a* | b* |
| 0 | 23.86 | 36.74 | 40.94 | 22.8 | 36.35 | 39.13 | 22.93 | 36.21 | 39.28 |
| 30 | 42.84 | 36.99 | 69.17 | 50.1 | 32.66 | 74.1 | 55.18 | 29.09 | 76.36 |
| 60 | 50.66 | 33.33 | 76.22 | 59.28 | 26.05 | 76.58 | 64.52 | 22.13 | 78.34 |
| 120 | 56.67 | 29.22 | 78.07 | 65.22 | 21.15 | 76.76 | 69.21 | 18.33 | 78.78 |
| 150 | 59.88 | 26.7 | 78.35 | 68.17 | 18.75 | 76.54 | 70.87 | 17.61 | 79.56 |
| 180 | 62.02 | 24.95 | 78.47 | 70.03 | 17.23 | 76.21 | 71.66 | 17.36 | 80.26 |
| 240 | 64.8 | 22.48 | 78.27 | 71.95 | 15.79 | 76.16 | 71.66 | 18.26 | 82.18 |
| 300 | 66.94 | 20.52 | 77.84 | 73.44 | 14.58 | 75.76 | 68.82 | 21.76 | 85.67 |

The results demonstrate that increasing the temperature results in faster bleaching of the product, with equilibrium reaching after 120 minutes at 90° C., 150 minutes at 80° C. and 270 minutes at 70° C. Bleaching at higher temperatures did not result in significant inactivation of the hydrogen peroxide.

### Example 4—Bleaching with Potassium Metabisulfite

The following Examples were prepared from brewer's spent grain comprising spent barley and spent rice using the General method. The spray dried product was dissolved in water to a concentration of 5% protein by weight and treated with potassium metabisulfite (KMS) (VINOFERM Campden) at 66° C. for 180 mins. The potassium metabisulfite dosage is defined as a multiple of X, where X=100 g KMS per kg of protein.

The colour of the solution was measured using the L*a*b method during bleaching. The L*a*b scores at start and at the end of the treatment time are shown in Table 11.

TABLE 11

| KMS | L* | | | L* | | |
|---|---|---|---|---|---|---|
| dosage | (start) | a*(start) | b*(start) | (end) | a*(end) | b*(end) |
| 1X | 20.46 | 35.91 | 35.22 | 31.42 | 35.75 | 52.69 |
| 5X | 20.46 | 35.91 | 35.22 | 37.95 | 35.71 | 61.58 |
| 10X | 20.46 | 35.91 | 35.22 | 34.71 | 34.94 | 57.33 |

### Example 5—Bleaching with Urea Hydrogen Peroxide

The following Examples were prepared from brewer's spent grain comprising spent barley and spent rice using the General method. The spray dried product was dissolved in water to a concentration of 5% protein by weight and treated with a solution of urea hydrogen peroxide (UHP) (ThermoFisher Scientific Hydrogen peroxide-urea ≥97%) in water (35% w/w) at 66° C. for 120 minutes under the conditions in Table 12 below. The UHP dosage is defined as a multiple of X, where X=3 g UHP (35% w/w) per kg of protein.

The colour of the solution was measured using the L*a*b method during bleaching. The L*a*b scores at start and at the end of the treatment time are shown in Table 12.

TABLE 12

| UHP | Start | | | End | | |
|---|---|---|---|---|---|---|
| Dosage | L* | a* | b* | L* | a* | b* |
| 1X | 20.01 | 36.39 | 34.32 | 39.5 | 36.7 | 64.93 |
| 2.3X | 20.01 | 36.39 | 34.32 | 61.38 | 24.76 | 80.56 |
| 4.6X | 20.01 | 36.39 | 34.32 | 73.29 | 14.38 | 76.99 |

### Example 6—Measuring the Effect of Bleaching on the Amino Acid and Polyphenol Content and Measuring the In Vitro Digestibility of the Bleached Product

The protein isolates in the following Examples were prepared according to the General method from brewer's spent grain comprising spent barley and spent rice. The spray-dried product was used as is for the unbleached sample. The spray dried product was bleached at 5 wt % protein solution with hydrogen peroxide (34% (w/w)) at a dosage of 8X and temperature of 66° C. for 180 mins to prepare the bleached sample. The hydrogen peroxide dosage is defined as a multiple of X, where X=50 g of hydrogen peroxide (34% w/w) per kg of protein.

The amino acid content of each sample is shown in Table 13.

TABLE 13

| | Unbleached sample | Bleached sample |
|---|---|---|
| Amino Acid | (g/100 g) | (g/100 g) |
| Alanine | 4.95 | 4.80 |
| Arginine | 5.41 | 4.93 |
| Aspartic acid | 9.29 | 9.61 |
| Glutamic acid | 23.45 | 26.69 |
| Glycine | 4.47 | 4.33 |
| Histidine | 2.33 | 1.44 |
| Isoleucine | 4.26 | 3.92 |
| Leucine | 7.68 | 7.07 |
| Lysine | 3.99 | 3.42 |
| Phenylalanine | 5.85 | 5.71 |
| Proline | 10.11 | 11.02 |
| Serine | 4.41 | 4.49 |
| Threonine | 3.73 | 3.65 |
| Tyrosine | 4.20 | 3.32 |
| Valine | 5.88 | 5.60 |

The data in Table 13 show that the bleaching process has a minimal impact on the amino acid content of the product.

The polyphenol content products produced by the process (Bleached) and products produced by an identical process by without a step of bleaching (Unbleached) were measured by the Folin-Ciocalteu (or gallic acid equivalent) method and is shown in Table 14 below.

TABLE 14

| Sample | Polyphenol content (mg/kg) |
|---|---|
| Unbleached | 40,600 |
| Unbleached | 43,500 |
| Bleached | 28,500 |

The bleaching process reduces the polyphenol content significantly, by approximately a third according to the data in the above table.

The in vitro digestibility of the bleached product was 1.00 (100%) as measured by Medallion Labs on a 150 g sample using the method set out in U.S. patent application Ser. No. 14/599,050.

### Example 7—Sensory Profile Testing

Sensory profile evaluation was carried out by 10 trained descriptive panellists who evaluated the below products for appearance, aroma and mouthfeel using the Spectrum™ Method of sensory analysis. The samples of each product were tested in water (5% by weight) at 85% protein.
Bleached—a product prepared according to the process of the present invention; and,
Unbleached—a product prepared by the General method described hereinabove without a step of bleaching with a bleaching agent.

TABLE 15

| Attribute | Unbleached | Bleached |
|---|---|---|
| Hue Intensity | 14.4 | 11.1 |
| Opacity | 14.6 | 12.3 |
| Amount of surface | 7.2 | 5.6 |
| bubbles/foam | | |
| Surface shine | 10.3 | 11.1 |
| Surface oiliness | 0* | 0* |
| Overall aroma | 5.8* | 5.6* |
| Grain complex aroma | 1.8 | 2.3 |
| Malt aroma | 1.0 | 1.7 |
| Cardboardy aroma | 1.5 | 0.9 |
| Hydrolyzed vegetable | 0.8 | 0.4 |
| protein (HVP) aroma | | |
| Overall flavour | 6.7 | 5.8 |
| Burnt grain flavour | 0.9 | 0.4 |
| Cardboardy flavour | 1.1* | 1.0* |
| HVP flavour | 0.7 | 0.3 |
| Bitter flavour | 2.9 | 2.0 |
| Residual bitter flavour | 1.4 | 0.4 |

*Attribute intensities are not significantly different at 95% confidence level.

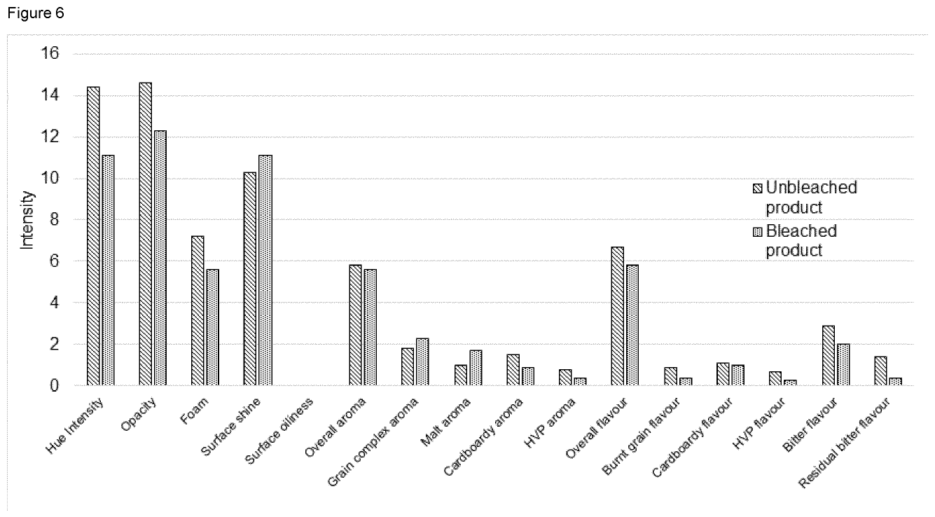

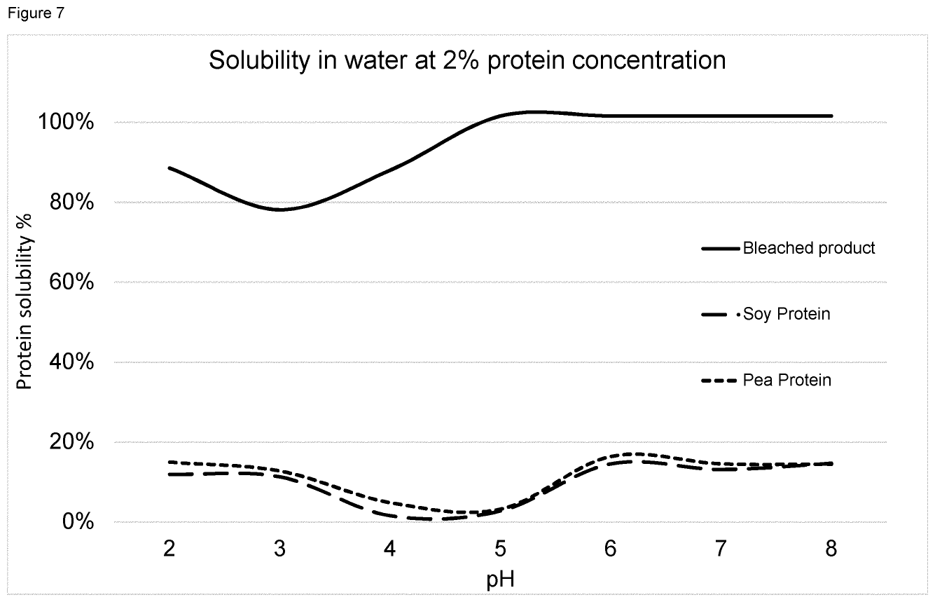

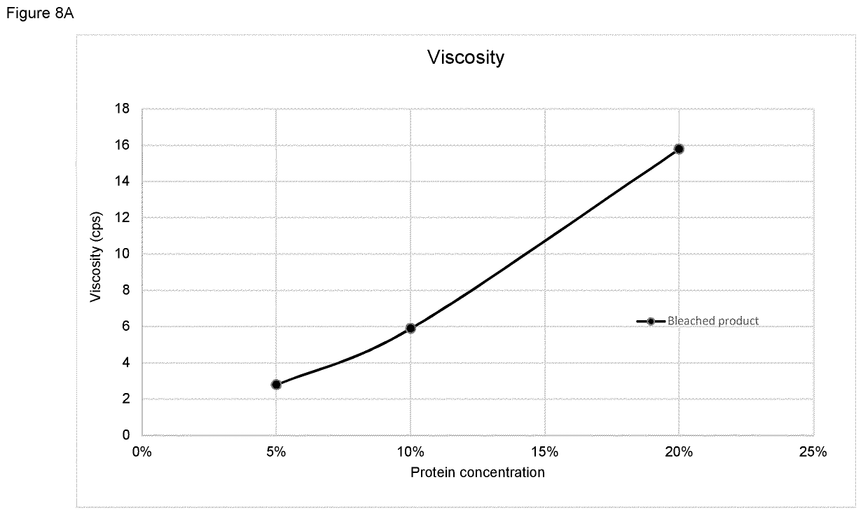

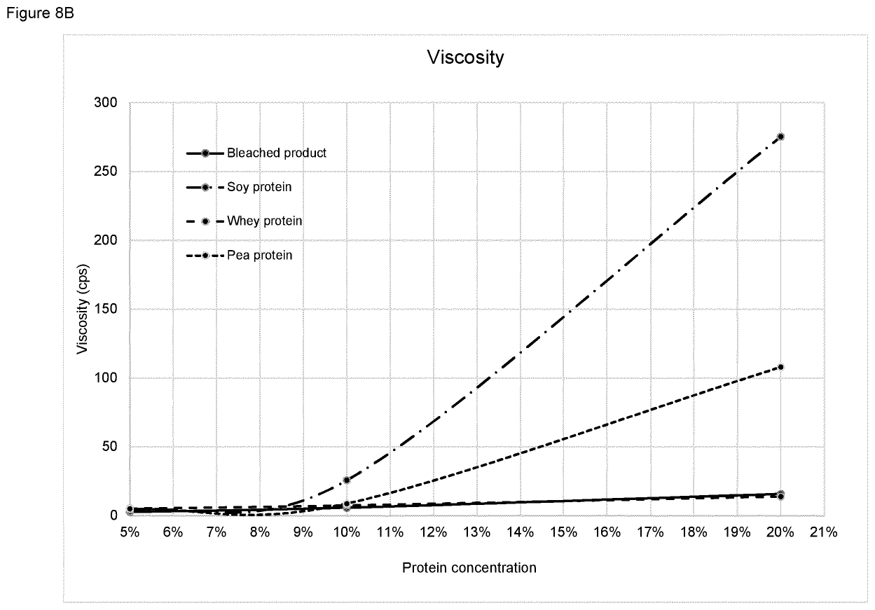

The data in Table 15, which are illustrated in FIG. 6, demonstrate that the product of the present invention has a significantly reduced hue intensity, opacity, foaming and overall flavour compared to a product prepared by the same method but without a step of bleaching. A number of specific flavour and aroma attributes are significantly reduced as well. Accordingly, the product of the present invention will have a reduced impact on the flavour, aroma and appearance of a comestible when it is mixed with other ingredients to prepare a comestible when compared to a product that has not undergone the bleaching process of the present invention.

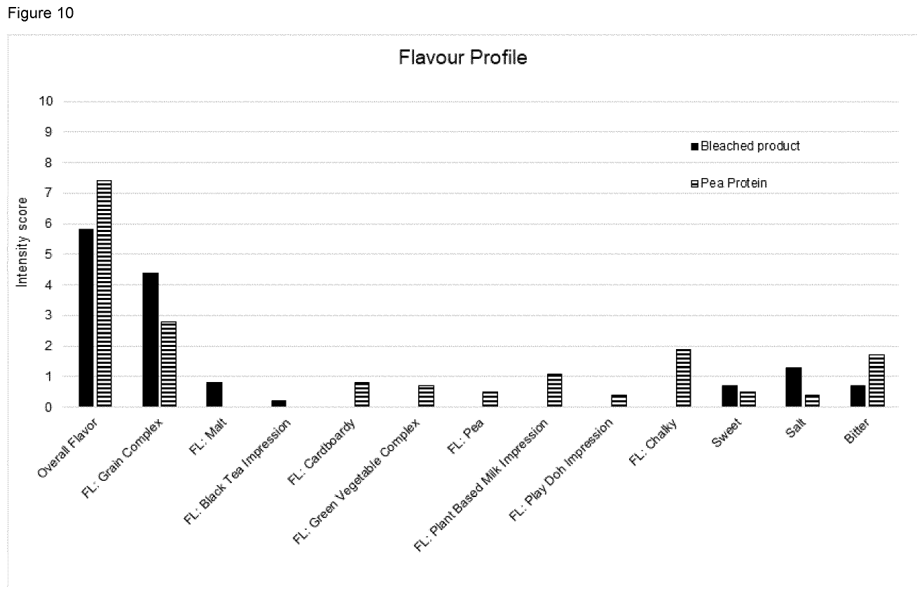

The same sensory profile evaluation method was used to compare the bleached product with a commercial pea protein product, the results of which are shown in Table 16 and FIG. 10.

TABLE 16

| Attribute | Bleached product | Pea protein |
|---|---|---|
| Overall flavour | 5.8 | 7.4 |
| Grain complex flavour | 4.4 | 2.8 |
| Malt flavour | 0.8 | 0 |
| Black tea impression | 0.2 | 0 |
| Cardboardy flavour | 0 | 0.8 |
| Green vegetable complex | 0 | 0.7 |
| Pea | 0 | 0.5 |
| Plant-based milk | 0 | 1.1 |
| impression | | |
| Play-Doh impression | 0 | 0.4 |
| Chalky | 0 | 1.9 |
| Sweet | 0.7 | 0.5 |
| Salt | 1.3 | 0.4 |
| Bitter | 0.7 | 1.7 |

The results show that the bleached product has a reduced overall flavour, grain complex flavour, and bitter flavour compared to the pea protein product. Accordingly, the product of the present invention will have a reduced impact on the flavour of a comestible when it is mixed with other ingredients to prepare the comestible compared to the pea protein product. Additionally, flavours including green vegetable, pea, plant-based milk, Play-Doh and chalky, which are present in the pea protein product are not present in the bleached product.

### Examples of Inactivating Hydrogen Peroxide

### Example 9—Inactivation by Enzymatic Treatment

The protein isolates in the following Examples were prepared according to the General method from brewer's spent grain comprising spent barley and spent rice. The spray dried product was dissolved in water to a concentration of 5% protein by weight and bleached with hydrogen peroxide (Solvay Interox® ST-35 (35% w/w)) at a dosage of 7X at pH 7 and 90° C. for 30 mins, where X=50 g of hydrogen peroxide (35% w/w) per kg of protein.

The bleached solution was treated with a catalase enzyme (Catazyme® 25 L from Novozymes®) at a concentration of 25,000 CIU/g according to the conditions in Table 17. Inactivation time refers to the time to reach a hydrogen peroxide concentration of less than 0.5 ppm as measured by Quantofix® Peroxide 100 test strips.

TABLE 17

| | | Enzyme dosage | |
|---|---|---|---|
| | | (mL/L protein | Inactivation |
| pH | Temperature (° C.) | solution) | time (min) |
| Native* | 70 | 0.2 | 30 |
| Native* | 70 | 0.25 | 20 |
| 7 | 70 | 0.25 | 25 |
| 8 | 70 | 0.25 | N/A^{#} |
| Native* | 70 | 0.3 | 15 |
| Native* | 70 | 0.4 | 15 |
| Native* | 70 | 0.6 | 10 |

^{#}The peroxide was not inactivated under these conditions.
*Native indicates that no pH adjustment was performed. The pH was 7.4-7.5.

### Example 10—Inactivation by Ascorbic Acid

The protein isolates in the following Examples were prepared according to the General method from brewer's spent grain comprising spent barley and spent rice. The spray dried product was dissolved in water to a concentration of 5% protein by weight and bleached under the following conditions with hydrogen peroxide (Solvay Interox® ST-35 (35% w/w)) at a dosage of 7X at pH 7 and 90° C. for 30 mins, where X=50 g of hydrogen peroxide (35% w/w) per kg of protein.

The bleached solution was subsequently treated with ascorbic acid under the conditions in Table 18. Inactivation time refers to the time to reach a hydrogen peroxide concentration of less than 0.5 ppm as measured by Quantofix® Peroxide 100 test strips.

TABLE 18

| | Ascorbic acid | Inactivation time |
|---|---|---|
| Temperature (° C.) | dosage g/L | (min) |
| 45 | 0.5 | >40 |
| 45 | 0.7 | <10 |
| 45 | 1 | <10 |
| 65 | 0.6 | >40 |
| 75 | 0.6 | >40 |
| 85 | 0.6 | 40 (10 ppm) |

Increasing the dosage of ascorbic acid had a greater impact on the inactivation time than increasing the temperature, although increasing the temperature did speed up the inactivation process. Dosages of ascorbic acid above 1 g/L can lower the pH, which may cause protein precipitation.

### Example 11—Inactivation by Boiling

The protein isolates in the following Examples were prepared according to the General method from brewer's spent grain comprising spent barley and spent rice. The spray dried product was dissolved in water to a concentration of 5% protein by weight and bleached according to the conditions in Table 19. After the stated time for the bleaching step in Table 18, the samples were left for the intermediate time stated, after which hydrogen peroxide inactivation was achieved by increasing the temperature to 100° C. for the time stated. The hydrogen peroxide (Solvay Interox® ST-35 (35% w/w)) dosage is defined as a multiple of X, where X=50 g of hydrogen peroxide (35% w/w) per kg of protein. Boiling proceeded until a hydrogen peroxide concentration of less than 0.5 ppm was reached as measured by Quantofix® Peroxide 100 test strips.

TABLE 19

| Bleaching conditions | | | | | Intermediate | Inactivation conditions | | |
|---|---|---|---|---|---|---|---|---|
| | Temp | Dosage | Time | L* | time | Time | Temp | L* |
| pH | (° C.) | (X) | (min) | score | (min) | (min) | (° C.) | score |
| 8 | 90 | 5 | 60 | 77.46 | 8 | 30 | 100 | 70.76 |
| 7 | 80 | 5 | 50 | 75 | 11 | 50 | 100 | 65.29 |
| 7 | 85 | 8 | 60 | 83.61 | 14 | 40 | 100 | 86 |
| 7.5 | 90 | 5.2 | 40 | 74.86 | 11 | 30 | 100 | 61.57 |
| 7 | 90 | 7 | 30 | 79.12 | 60 | 10 | 100 | 77.3 |

The boiling time required increased with an increase in the hydrogen peroxide dosage.

### Example 12—Comestibles Prepared Using the Protein Isolate

### Coffee Creamer

Ingredients: Protein isolate of the present invention, medium chain triglyceride (MCT) oil, maltodextrin, acacia gum, sunflower lecithin, natural flavours. Add 20 g to a cup of coffee.

### Plant-Based Milk Substitute

Ingredients: Water, faba bean protein, protein isolate of the present invention, coconut cream, canola oil, sugar, calcium, natural flavours, gellan gum, locust bean gum, dipotassium sulfate, sunflower lecithin.

### Plant-Based Milk Substitute

Ingredients: Water, oat powder, pea protein, protein isolate of the present invention, coconut cream, sugar, soluble corn fiber, calcium, natural flavours, soy protein isolate, gellan gum, locust bean gum, dipotassium phosphate, sunflower lecithin.

### Ready-to-Mix Vanilla Beverage

Ingredients: Pea protein, protein isolate of the present invention, medium chain triglyceride (MCT) oil, maltodextrin, acacia gum, sugar, natural flavours, xanthan gum, stevia extract and Sucralose®. Blend 32 g with one cup (8 oz) of water or plant-based milk substitute.

### Ready-to-Drink Strawberry Beverage

Ingredients: Water, pea protein, protein isolate of the present invention, sugar, sunflower oil, natural flavours, calcium carbonate, cellulose gel, cellulose gum, sunflower lecithin, stevia.

### Ready-to-Drink Vanilla Beverage

Ingredients: Water, protein isolate of the present invention, pea protein, sugar, canola oil, natural flavours, calcium carbonate, cellulose gel, sunflower lecithin, Sucralose®.

1. A process for isolating a protein isolate from a grain material, the process comprising:
a) subjecting an aqueous slurry of the grain material to enzymatic protein hydrolysis to produce a liquid protein stream;
b) removing solids from the liquid protein stream;
c) subjecting the liquid protein stream to one or more filtration steps;
d) processing the liquid protein stream to produce the protein isolate;
wherein the process further comprises, either during or after step (c), a step of treating the liquid protein stream with a bleaching agent at a temperature of at least 50° C. and a pH of at least 5.

2. The process according to claim 1, wherein the grain material is selected from brewer's spent grain, barley, barley malt, rice, corn and combinations thereof.

3. The process according to claim 1, wherein the brewer's spent grain comprises spent barley.

4. The process according to claim 1, wherein the bleaching agent is an oxidising agent or a reducing agent.

5. The process according to claim 1, wherein the bleaching agent is one or more selected from the group consisting of potassium metabisulfite, benzoyl hydrogen peroxide, urea hydrogen peroxide, and hydrogen peroxide.

6. The process according to claim 1, wherein the bleaching agent is hydrogen peroxide.

7. The process according to claim 1, wherein the amount of the bleaching agent is at least 0.25 moles of beaching agent per kilogram of protein.

8. The process according to claim 1, wherein the amount of the bleaching agent is from 2.5 to 50 moles of beaching agent per kilogram of protein.

9. The process according to claim 1, wherein the amount of bleaching agent is at least 17.5 grams of bleaching agent per kilogram of protein.

10. The process according to claim 1, wherein the temperature during the step of treating the liquid protein stream with a bleaching agent is from 50 to 100° C.

11. The process according to claim 1, wherein the pH during the step of treating the liquid protein stream with a bleaching agent is from 5 to 10.

12. The process according to claim 1, wherein the pH is maintained at a value of at least 5 during the step of treating the liquid protein stream with a bleaching agent.

13. The process according to claim 1, wherein the step of treating the liquid protein stream with a bleaching agent is performed for up to 5 hours.

14. The process according to claim 1, wherein the protein concentration during the step of treating with a bleaching agent is from 0.1 to 40% by weight of the liquid protein stream.

15. The process according to claim 1, wherein the step of treating the liquid protein stream with a bleaching agent comprises treating the liquid protein stream with a bleaching agent:
in an amount of from 2.5 to 50 moles of bleaching agent per kilogram of protein or of from 85 to 175 grams of bleaching agent per kilogram of protein;
at a pH of from 7 to 8;
at a temperature of from 80 to 95° C.;
for a time of from 20 to 45 minutes; and
at a protein concentration of from 1 to 20% by weight of the liquid protein stream.

16. The process according to claim 1, wherein step c) of subjecting the liquid protein stream to one or more filtration steps comprises a microfiltration step and one or more nanofiltration steps.

17. The process according to claim 1, wherein the step of treating the liquid protein stream with the bleaching agent is performed during step (c).

18. The process according to claim 1, wherein step c) comprises:
c1) subjecting the liquid protein stream to microfiltration to obtain a microfiltration permeate comprising protein and a microfiltration retentate;
c2) subjecting the microfiltration permeate to the step of treating with the bleaching agent to provide a bleached microfiltration permeate; and
c3) subjecting the bleached microfiltration permeate to nanofiltration to obtain a nanofiltration permeate and a nanofiltration retentate comprising protein; and
wherein step d) comprises:
d) processing the nanofiltration retentate to produce the protein isolate.

19. The process according to claim 18, further comprising, before the step of treating with a bleaching agent, a step of concentrating the microfiltration permeate to provide a concentrated microfiltration permeate.

20. The process according to claim 1, wherein step c) comprises:
c1′) subjecting the liquid protein stream to microfiltration to obtain a microfiltration permeate comprising protein and a microfiltration retentate;
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate comprising protein;
c4′) subjecting the bleached nanofiltration retentate to nanofiltration to obtain a second nanofiltration permeate and a second nanofiltration retentate comprising protein; and
wherein step d) comprises:
d) processing the second nanofiltration retentate to produce the protein isolate.

21. The process according to claim 1, wherein the step of treating the liquid protein stream with a bleaching agent is performed after step c).

22. The process according to claim 1, wherein step c) comprises:
c1′) subjecting the liquid protein stream to microfiltration to obtain a microfiltration permeate comprising protein and a microfiltration retentate; and
c2′) subjecting the microfiltration permeate to nanofiltration to obtain a nanofiltration permeate and a nanofiltration retentate comprising protein;
c3′) subjecting the nanofiltration retentate to the step of treating with a bleaching agent to provide a bleached nanofiltration retentate; and
wherein step d) comprises:
d) processing the bleached nanofiltration retentate to produce the protein isolate.

23. The process according to claim 1, wherein step d) comprises:
evaporating to increase the total solids content of the liquid protein stream to a total solids content of from 20 to 55%; and
spray drying to produce the protein isolate.

24. The process according to claim 1, wherein the process further comprises a step of filtering with activated carbon prior to step (d).

25. The process according to claim 1, wherein the process further comprises a step of inactivating the bleaching agent by heating, ascorbic acid treatment, or enzymatic treatment.

26. The process according to claim 25, wherein the enzymatic treatment comprises treatment with an enzyme composition comprising a catalase.

27. The process according to claim 25, wherein, before the step of inactivating the bleaching agent, the temperature of the liquid protein stream is adjusted by heat exchange.

28. The process according to claim 25, wherein the process is carried out in accordance with claim 18 and the step of inactivating the bleaching agent occurs between steps c2) and c3).

29. The process according to claim 25, wherein the process is carried out in accordance with claim 20 and the step of inactivating the bleaching agent occurs between steps c3′) and c4′).

30. The process according to claim 25, wherein the process is carried out in accordance with claim 22 and the step of inactivating the bleaching agent occurs between steps d1′) and d).

31. The process according to claim 25, wherein the concentration of the bleaching agent in the liquid protein stream at the end of the step of inactivating is less than 1 ppm.

32. The process according to claim 1, wherein the protein isolate has an L* score of at least 60, as measured by the CIELAB method.

33. The process according to claim 1, wherein the protein isolate has one or more of the following features:
an L* score in aqueous solution at 5% protein by weight that is at least 1.25 times higher than that of a protein isolate isolated from a grain material produced by the process of claim 1 without a step of treating the liquid protein stream with a bleaching agent;
a total polyphenol content of between 10,000 and 50,000 mg/kg of the protein isolate as determined by the Folin-Ciocalteu method;
a total polyphenol content as determined by the Folin-Ciocalteu method that is 40% to 80% that of a protein isolate isolated from a grain material produced by the process of claim 1 without a step of treating the liquid protein stream with a bleaching agent;
an average molecular weight of from 3,000 to 30,000 Da; and
a concentration of bleaching agent of less than 1 ppm.

34. The process according to claim 1, wherein the protein isolate has one or more of the following features:
a solubility in water at a pH of 8 or less of at least 70% at a protein concentration of 2% dry matter, as determined by the Kjeldahl method using a conversion factor of 6.25;
a viscosity in water at a protein concentration of 5% dry matter of less than 5 mPa·s;
a viscosity in water at a protein concentration of 20% dry matter of from 10 to 25 mPa·s;
a percentage of protein in the protein isolate having a molecular weight of 1000 Da or less of less than 15% by weight of the protein in the protein isolate; and/or
an in vitro digestibility of at least 80%, preferably from 80 to 100%, most preferably 100%.

35. A protein isolate obtainable by the process according to claim 1.

36. A protein isolate isolated from a grain material, wherein the protein isolate has an L* score of at least 60 in aqueous solution at 5% protein by weight, as measured by the CIELAB method.

37. The protein isolate according to claim 36, wherein the protein isolate has one or more of the following features:
an L* score in aqueous solution at 5% protein by weight that is at least 1.25 times higher than that of a protein isolate isolated from a grain material produced by the process of claim 1 without a step of treating the liquid protein stream with a bleaching agent;
a total polyphenol content of between 10,000 and 50,000 mg/kg of the protein isolate as determined by the Folin-Ciocalteu method;
a total polyphenol content as determined by the Folin-Ciocalteu method that is 40% to 80% that of a protein isolate isolated from a grain material produced by the process of claim 1 without a step of treating the liquid protein stream with a bleaching agent;
an average molecular weight of from 3,000 to 30,000 Da; and
a concentration of bleaching agent of less than 1 ppm.

38. The protein isolate according to claim 36, wherein the protein isolate has one or more of the following features:
a solubility in water at a pH of 8 or less of at least 70% at a protein concentration of 2% dry matter, as determined by the Kjeldahl method using a conversion factor of 6.25;
a viscosity in water at a protein concentration of 5% dry matter of less than 5 mPa·s;
a viscosity in water at a protein concentration of 20% dry matter of from 10 to 25 mPa·s;
a percentage of protein in the protein isolate having a molecular weight of 1000 Da or less of less than 15% by weight of the protein in the protein isolate; and/or
an in vitro digestibility of at least 80%.

39. A food or beverage comprising the protein isolate obtainable by the process according to claim 1.

40. A food or beverage comprising the protein isolate according to claim 36.
